(19) United States
(12) Patent Application Publication
(10) Pub. No.: US 2025/0315620 A1
(43) Pub. Date: Oct. 9, 2025

(54) DOMAIN-SPECIFIC MODEL FOR SURFACING HIGH-SURPRISAL INFORMATION

(71) Applicant: The University of Chicago, Chicago, IL (US)

(72) Inventors: Anna Costello, Chicago, IL (US); Bradford Levy, Chicago, IL (US); Valeri Nikolaev, Chicago, IL (US)

(21) Appl. No.: 19/169,692

(22) Filed: Apr. 3, 2025

Related U.S. Application Data
(60) Provisional application No. 63/573,925, filed on Apr. 3, 2024.

(51) Int. Cl. G06F 40/284; G06F 40/40; G06N 3/0455; G06N 3/047

(52) U.S. Cl. CPC G06F 40/284; G06F 40/40; G06N 3/0455; G06N 3/047

(57) ABSTRACT

A method of surfacing high-surprisal information includes reading an input document. The input document can comprise an ordered sequence of tokens. The method includes, for each token of the ordered sequence of tokens, generating by a language model a probability distribution of predicted tokens based on preceding tokens in the ordered sequence. The method includes comparing each token to its predicted tokens to determine a probability of occurrence of that token. The method includes, based on the probability of occurrence of each token, assigning a surprise value thereto.

### RELATED APPLICATION(S)

This application claims the benefit of priority to U.S. Provisional Application No. 63/573,925, filed Apr. 3, 2024, which is incorporated by reference in its entirety.

### BACKGROUND

The volume of data that is created by humans has grown at a rate of 54% per year over the last decade. Ninety percent of this data is unstructured data, and much of that unstructured data is in the form of narrative text.

### BRIEF SUMMARY

According to embodiments of the present disclosure, methods of and computer program products for surfacing high-surprisal information are provided.

In some embodiments, a method of surfacing high-surprisal information includes reading an input document. The input document can comprise an ordered sequence of tokens. In some embodiments, the method includes, for each token of the ordered sequence of tokens, generating by a language model a probability distribution of predicted tokens based on preceding tokens in the ordered sequence. In some embodiments, the method includes comparing each token to its predicted tokens to determine a probability of occurrence of that token. In some embodiments, the method includes, based on the probability of occurrence of each token, assigning a surprise value thereto.

In some embodiments, the language model is trained by reading a corpus of documents. Each document of the corpus can be associated with a context of a plurality of contexts. The language model can be trained by training a domain-neutral language model on the corpus of documents. The language model can be trained by generating a domain-specific language model based on the domain-neutral language model. The domain-specific language model can be associated with a target context and a plurality of documents associated with the target context.

In some embodiments, generating the domain-specific language model further comprises training the domain-specific language model based on a plurality of documents associated with the target context.

In some embodiments, the target context is one of the plurality of contexts.

In some embodiments, training the domain-neutral language model on the corpus of documents comprises, for each of a plurality of parameters of the domain-neutral language model, initializing that parameter with a random value.

In some embodiments, generating the domain-specific language model further comprises initializing a first plurality of parameters of the domain-specific language model with a second plurality of parameters of the domain-neutral language model.

In some embodiments, the domain-neutral language model and domain-specific language model each employ a transformer neural network architecture.

In some embodiments, the domain-specific language model is further trained by tokenizing each document of the corpus to a plurality of tokens. Training the domain-neutral language model can be based on the pluralities of tokens.

In some embodiments, each document of the corpus has an associated creation time. In some embodiments, the input document has an associated creation time later than the creation times of the documents of the corpus.

In some embodiments, the method includes assigning a plurality of tokens to a prediction window. In some embodiments, the method includes combining the surprise value of each token of the plurality of tokens assigned to the prediction window. In some embodiments, the method includes providing a prediction window surprise value based on the combined surprise values. In some embodiments, the prediction window corresponds to a phrase, sentence, or paragraph.

In some embodiments, the surprise value is a difference between the probability of occurrence and a highest expected probability in the probability distribution.

In some embodiments, the method includes displaying the input document with a visualization of the surprise value associated with each of the ordered sequence of tokens.

In some embodiments, the visualization comprises a level of highlighting proportional to the surprise value. In some embodiments, the visualization comprises a variation in one or more of font, color, size, and visibility.

In some embodiments, method of training a language model includes reading a corpus of documents. Each document of the corpus can be associated with a context of a plurality of contexts. In some embodiments, the method includes training a domain-neutral language model on the corpus of documents. In some embodiments, the method includes generating a domain-specific language model based on the domain-neutral language model, the domain-specific language model being associated with a target context. In some embodiments, the domain-specific language model is configured to receive an input document, the input document comprising an ordered sequence of tokens. In some embodiments, for each token of the ordered sequence of tokens, the domain-specific language model generates a probability distribution of predicted tokens based on preceding tokens in the ordered sequence. In some embodiments, the domain-specific language model compares each token to its predicted tokens to determine a probability of occurrence of that token. In some embodiments, based on the probability of occurrence of each token, the domain-specific language model assigns a surprise value thereto.

In some embodiments, generating the domain-specific language model further comprises training the domain-specific language model based on a plurality of documents associated with the target context.

In some embodiments, the target context is one of the plurality of contexts.

In some embodiments, training the domain-neutral language model on the corpus of documents comprises, for each of a plurality of parameters of the domain-neutral language model, initializing that parameter with a random value.

In some embodiments, generating the domain-specific language model further comprises initializing a first plurality of parameters of the domain-specific language model with a second plurality of parameters of the domain-neutral language model.

In some embodiments, the domain-neutral language model and domain-specific language model each employ a transformer neural network architecture.

In some embodiments, the method includes tokenizing each document of the corpus to a plurality of tokens. The domain-neutral language model can be further trained on the pluralities of tokens.

In some embodiments, the domain-specific language model is further configured to assign a plurality of tokens to a prediction window. In some embodiments, the domain-specific language model is further configured to combine the surprise value of each token of the plurality of tokens assigned to the prediction window. In some embodiments, the domain-specific language model is further configured to provide a prediction window surprise value based on the combined surprise values. In some embodiments, the prediction window corresponds to a phrase, sentence, or paragraph.

In some embodiments, the surprise value is a difference between the probability of occurrence and a highest expected probability in the probability distribution.

In some embodiments, a computer program product comprises a computer readable storage medium having program instructions embodied therewith. The program instructions can be executable by a processor to perform any of the above methods.

### BRIEF DESCRIPTION OF THE SEVERAL VIEWS OF THE DRAWINGS

FIG. 1A is a block diagram of an LLM Model Factory training a domain-neutral model according to embodiments of the present disclosure.

FIG. 1B is a block diagram of an LLM Model Factory training a domain-specific model according to embodiments of the present disclosure.

FIG. 1C is a block diagram of the domain-specific model determining a surprise value according to embodiments of the present disclosure.

FIG. 2 is a data partition of training data used to train a cross-sectional model and inference data according to embodiments of the present disclosure.

FIG. 3 is a representation of document having variably highlighted sentences according to embodiments of the present disclosure.

FIG. 4 depicts graphs representing an information metric as a function of position in the document according to embodiments of the present disclosure.

FIG. 5 depicts graphs representing whether the average high-surprisal information in a filing is above or below the median as a function of normalized position in the document according to embodiments of the present disclosure.

FIG. 6 depicts graphs representing average daily values of AbsoluteReturn and Volume for a 10-day window around the filing date separately for filings that are above and below median info according to embodiments of the present disclosure.

FIG. 7 depicts graphs representing average daily values of AbsoluteReturn and Volume for the 10-day window around the filing date separately for filings that are above and below median info according to embodiments of the present disclosure.

FIG. 8 depicts graphs representing average daily values of AbsoluteReturn and Volume for the 10-day window around the filing date separately for filings that are above and below median info according to embodiments of the present disclosure.

FIG. 9 is a graph plotting the average value of AbsoluteReturn for t=0 as a function of Info according to embodiments of the present disclosure.

FIG. 10 is a graph plotting the average value of AbsoluteReturn for t=0 as a function of Info according to embodiments of the present disclosure.

FIG. 11 depicts graphs plotting example average daily values of AbnormalReturn and Volume in the 10-day window around the filing date separately for filings that are above and below median Info×FinNeg for annual and quarterly reports according to embodiments of the present disclosure.

FIG. 12 depicts graphs plotting example average daily values of AbnormalReturn and Volume in the 10-day window around the filing date separately for filings that are above and below median Info×FinNeg for current reports according to embodiments of the present disclosure.

FIG. 13 depicts graphs plotting example average daily values of AbnormalReturn and Volume in the 10-day window around the filing date separately for filings that are above and below median Info×FinNeg for Management's Discussion and Analysis (MD&A) according to embodiments of the present disclosure.

FIGS. 14A-C are graphs that plots example average values of AbnormalReturn and Volume for t=0 as a function of Info×FinNeg according to embodiments of the present disclosure.

FIG. 15 is a flowchart illustrating a method of uncovering high-surprisal information according to embodiments of the present disclosure.

FIG. 16 is a flowchart illustrating a method of training a model to uncover high-surprisal information according to embodiments of the present disclosure.

FIG. 17 is a computing node according to embodiments of the present disclosure.

### DETAILED DESCRIPTION

With the growth of the volume of content over recent years, identifying information that is relevant within text data remains a challenge. It would be desirable for an automated system to identify information that is new in a given document relative to a set of known information. In some emvodiments, the present disclosure provides a language model such as a large language model (LLM) that determines new or surprising information within textual data. In some embodiments, a domain-neutral LLM is trained on a corpus of data from a plurality of domains, and a domain-specific LLM is trained on a target domain. Once trained, the LLM can identify new or surprising information in any new doccument or narrative disclosure.

### Training a Domain-Neutral Model

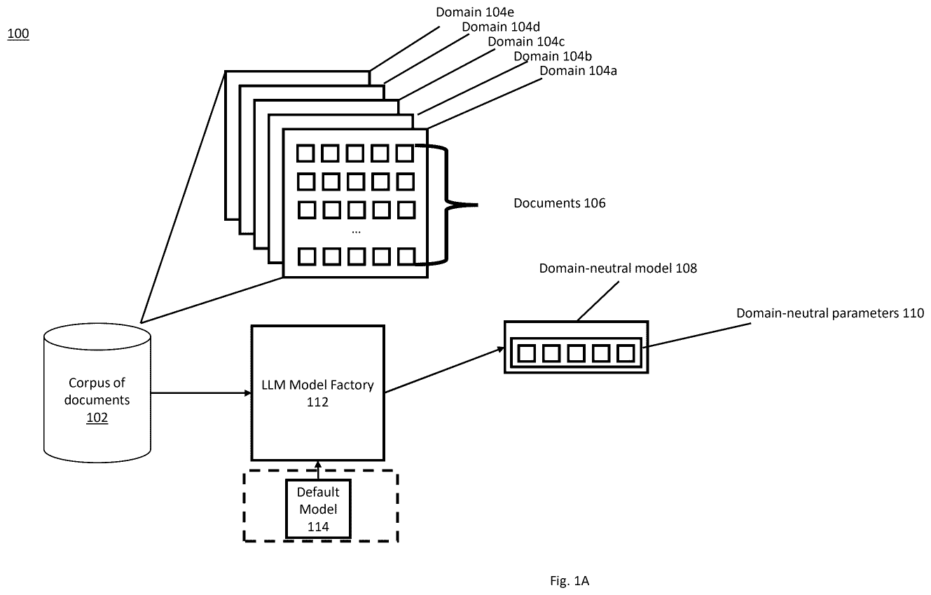

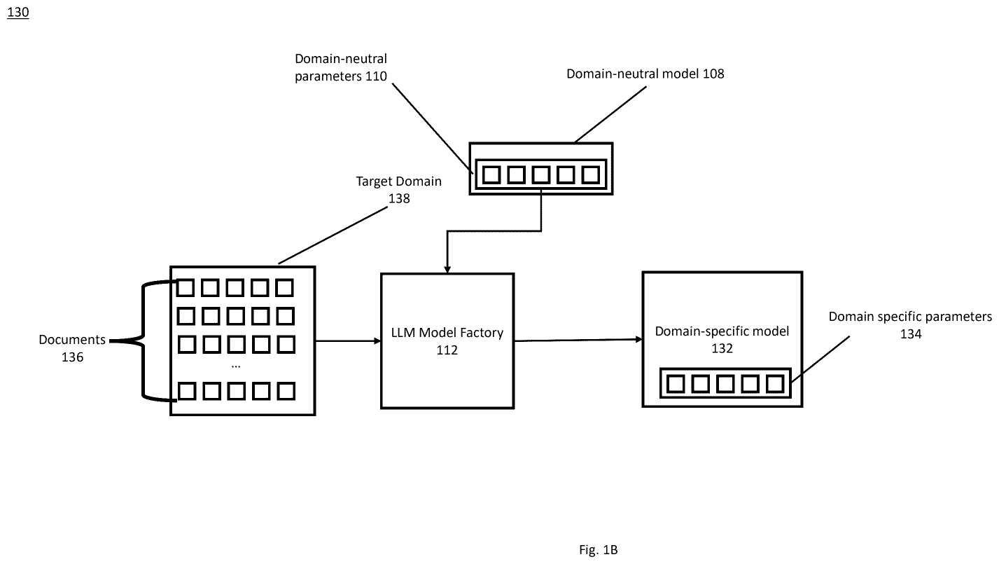

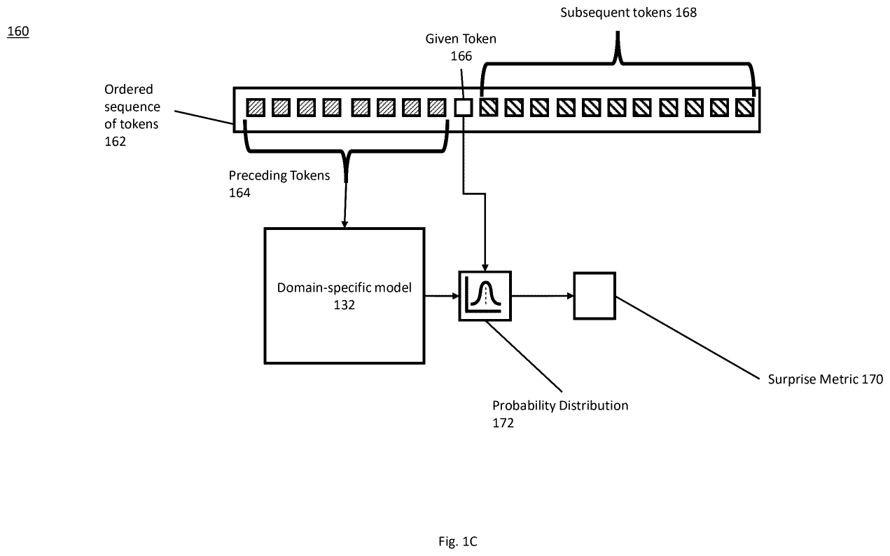

FIG. 1A is a block diagram 100 of an LLM Model Factory 112 training a domain-neutral model 108. In some embodiments, the domain-neutral model 108 is a language model such as a large language model (LLM). In some embodiments, the domain-neutral LLM 108 is trained on a corpus of documents 102. The corpus of documents 102 can be categorized into multiple domains 104a-e. Each of the multiple domains 104a-e includes multiple documents 106.

In some embodiment, a domain (e.g., domains 104a-e) can refer to a company, a corporation, an enterprise, an industry, a firm, an author, a periodical, a type of document (e.g., a contract, a license, a sales agreement, a purchase agreement, legislation), a subject-matter category, a source of the document, or other categorization of document.

In some embodiments, the documents 106 include unstructured text data. In some embodiments, the documents 106 include narrative disclosures. In some embodiments, the documents 106 are in the category of their respective domain 104a-e. For example, if domain 104a is the company Apple®, the documents 106 can be relating to that company. In some embodiments, the domains 104a-e are each a respective company. In some embodiments, each company is a company in a financial market. In some embodiments, the documents 106 can include corporate disclosures such as filings before the U.S. Securities and Exchange Commission (SEC) (e.g., Form 10-Q, Form 10-K, Form 8-K), or press releases of a company, etc.).

In some embodiments, the corpus of documents 102 are pre-processed to remove numerical data, such as tables. In some embodiments, the pre-processing focuses the training of the model 108 on the narrative content. In some embodiments, the pre-processing tokenizes the training data.

In some embodiments, a tokenizer can convert text into tokens and can encode the tokens as vectors for both training and use of the models. In some embodiments, the tokenizer is separate from the large language model and provides its output (e.g., an ordered sequence of tokens) to one or more large language model as training data or inference data. In some embodiments, the tokenizer can be considered part of the large language model. In some embodiments, the tokenizer can be applied to training documents, interence documents, or both.

While tokens can be based upon entire words (e.g., each full word being a unique token), however, tokenizing in such a way leads to a large vocabulary. In some embodiments, sub-piece or sub-word tokens can be employed because many words are constructed by combining sub-pieces together. For example, some sub-pieces may share meaning across the vocabulary (e.g., the prefix “un” in words such as unpresumptuous and unselfish).

Byte-Pair Encoding (BPE) can leverage commonality across words to build a vocabulary of a more manageable size. BPE can find a smaller number of unique sub-words in the corpus, along with individual characters (e.g., symbols) that can be used to form the words in the target vocabulary. BPE can merge pairs of adjacent individual characters/symbols which are most commonly found next to one another and can iterate this process until the vocabulary is reduced to a target size.

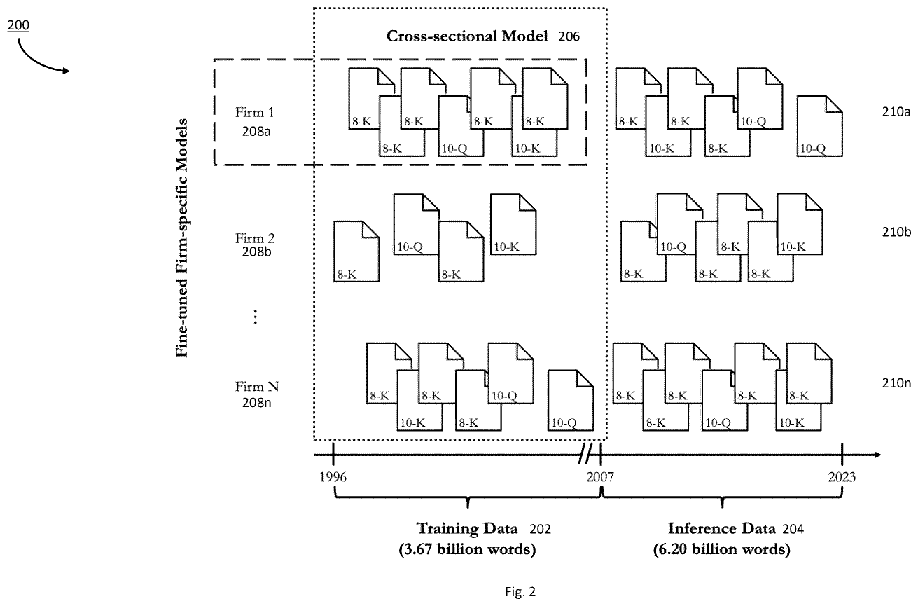

In some embodiments, a tokenizer is trained starting from a blank model (e.g., from scratch) using the disclosures within the corpus. In some embodiments, where the disclosures of the corpus are divided into in-sample training data (e.g., training data 202 of FIG. 2) and “out of sample” inference data (e.g., inference data 204 of FIG. 2), the tokenizer can be only trained on the in-sample training data. In some embodiments, the inputs to the training process include tokens for the Arabic numerals 0, 1, . . . 9. In some embodiments, this results in a tokenizer with a vocabulary size of about 50,270. In some embodiments, the vocabluary size represents the number of tokens learned via the training process, the ten Arabic numeral tokens, and three special tokens for beginning of sentence, end of sentence, and unknown (word that is not in the vocabulary).

In some embodiments, the documents of the corpus of documents 102 include timestamps representing a time of creation or time of publication of each document.

In some embodiments, the LLM Model Factory 112 trains a domain-neutral model 108 on the corpus of documents 102. In some embodiments, the LLM Model Factory 112 initializes the training with an default model 114. In some embodiments, the LLM Model Factory 112 initializes the training by setting the parameters of the domain-neutral model 108 to be trained to random non-zero values. In some embodiments, the LLM Model Factory 112 initializes the training by providing the default model 114 (e.g., a blank model) having parameters as random non-zero values. In some embodiments, after training, the domain-neutral model 108 includes domain-neutral parameters 110.

In some embodiments, the domain-specific LLMs estimate prior beliefs about a disclosure conditional on the information available at time t, e.g., pΩₜ( [symbol] ). As described above, a measure of information Iₜ( [symbol] ) can be:

$${I}_{t} ( 𝒟 ) = - log {\prod }_{i = 1}^{n} {p}_{{Ω}_{t}} ( {τ}_{i} \vert {τ}_{i - 1} , … , {τ}_{1} ) , \qquad ( 4 )$$

A collection of disclosures can be indexed by J=1, 2, . . . , m. The information set at time t can be approximated as \hat{Ω}ₜ={ [symbol] |j∈J}, where each disclosure [symbol] ⱼ can be a collection of tokens τ_{j,1} . . . , τ_{j,n}_{ⱼ}. A neural network parameterized by θ can be represented by \hat{p}_{Ω}_{ₜ} (⋅;θ). An emperical estimate of prior beliefs (e.g., an objective function) can be obtained by choosing θ such that

$$θ := arg {min}_{θ} {\sum }_{j = 1}^{m} {\sum }_{i = 1}^{{n}_{j}} - log {\hat{p}}_{{Ω}_{t}} ( {τ}_{j , i} \vert {τ}_{j , i - 1} , … , {τ}_{j , i - k} ; θ ) \qquad ( 5 )$$

where \hat{p}_{Ω}_{ₜ} (⋅;θ) is a multi-layer transformer neural network architecture (e.g., a LLM similar to “GPT-2”). In some embodiments, \hat{p}_{Ω}_{ₜ} (⋅;θ) can have a model size of 774 million parameters, and k is the size of the context window which can be set to 1,024. In some embodiments, the context window includes only tokens on preceding of t; in the ordered sequence of tokens t. In some embodiments, the objective function of Equation 5 is equivalent to maximizing a log-likelihood. In some embodiments, the objective is minimized using stochastic gradient descent with a batch size of 64. In some embodiments, memory constraints may require an actual batch size of eight. With such constraints, gradients can be accumulated for eight steps before performing a backward pass, yielding an effective batch size of 64. Each batch can include randomly sampled sequences of 512 contiguous tokens. For training the domain-neutral LLM (e.g., pre-training), a variable learning rate schedule that ramps from zero to a maximum learning rate of 2e-4 over the first 1000 batches and then follows a cosine decay to zero over 20 epochs can be employed. For training the domain-specific model (e.g., fine-tuning), a constant learning rate of 5e-5 can be employed.

In some embodiments, the domain-neutral model is trained from a blank model or model with randomly assigned weights (e.g., from scratch) on unstructured text data (e.g., historical narrative data, historical information, financial disclosures) contained in Ωₜ.

In some embodiments, a domain-neutral model is trained on a corpus, such as the narrative content extracted from the disclosures of all firms in sample filed on EDGAR from 1996 through the end of 2006. In some embodiments, the training data includes 22.8 GB of narrative content and more than 3.6 billion words.

In some embodiments, the filings gathered from the EDGAR database can contain a mix of narrative and quantitative content, such as tabular financial statements. In some embodiments, narrative content is extracted from the filings. In some embodiments, the method used to extract narrative content varies based on whether the file type of the narrative content is plain text or HTML.

In some embodiments, plain text filings and attachments-which are systematically older filings on average-often contain standardized general markup language (SGML) tags. In some embodiments, these tags can identify special content (e.g., tabular content) and render the special content in a more human-readable format based on the capabilities of the system used to view the content (e.g., a personal computer versus a Bloomberg Terminal). In some embodiments, these tags can identify tabular quantitative content in plain text filings and remove such tabular quantitative content.

In some embodiments, HTML filings and attachments use tables to structure content (e.g., present a graph on one half of the page while typesetting narrative content on the other half). In some embodiments, this increases the difficulty of removing tabular quantitative content. In some embodiments, the number of characters as rendered by a web browser per HTML tag is measured (CPT). Content is removed where more than a threshold percentage of the CPT measure are numbers. In some embodiments, content of HTML tags having a text density below a threshold are removed.

In some embodiments, a CPT threshold of 10 is used to identify narrative content embedded in HTML tables. In some embodiments, when the number of non-numeric, non-blank, and non-punctuation characters per tag in a given table exceeds 10, the narrative content is extracted from the table, and the content of the table is ignored or removed from the document.

After removing tables having a CPT less than 10, the text is extracted from the remaining HTML while preserving meaningful formatting such as indentation and line breaks. In some embodiments, this provides a corpus of documents 102 (e.g., a corpus of plain text documents) that are structurally similar regardless of source file type or the time period when the form was filed.

In some embodiments, the domain-neutral model is trained by randomly initializing the parameters θ, and training the domain-neutral model on the corpus for 10 epochs. In some embodiments, the training can be for more or less than 10 epochs. However, after 10 epochs, further training may only marginally the objective evaluated on an out-of-sample data set.

### Training a Domain-Specific Model

FIG. 1B is a block diagram 130 of an LLM Model Factory 112 training a domain-specific model 132. In some embodiments, the LLM Model Factory 112 trains a domain-specific model 132 for a target domain 138 (e.g., Domain 104a). In some embodiments, the domain-specific model 132 is a language model such as a large language model. In some embodiments, the target domain 138 can be any of the domains 104a-e used to train the domain-neutral model 108. In some embodiments, the target domain 138 can be a domain other than the domains 104a-e used to train the domain-neutral model 108.

In some embodiments, the LLM Model Factory 112 trains the domain-specific model 132 based on documents 136 from the target domain 138. In some embodiments, the target domain 138 can be one of the domains 104a-e used to train the domain-specific model. In such a case, the documents 136 can be the same documents 106 used to train the domain-neutral model 108 for that domain 104a-e or the documents 136 can be different in whole or in part from the documents 106 used to train the domain neutral model 108 for that domain 104a-e.

In some embodiments, the target domain 138 can be a domain different than any of the domains 104a-e. In such a case, the documents 136 can be different, at least in part, from the documents 106 used to train the domain-neutral model 108. In some embodiments, the documents 106 associated with the target domain 138 include timestamps.

In alternative approaches, fine-tuned models are based on a first model pre-trained on the entire corpus, including inference data. In contrast to these alternative approaches, some embodiments of the domain-neutral model 108 train on historical narrative data that is separate from the inference data.

In some embodiments, the LLM Model Factory 112 trains the domain-specific model 132 based on the documents 136 of the target domain 138. In some embodiments, the LLM Model Factory 112 initializes said training with domain-neutral parameters 110 from the domain-neutral model 108. In some embodiments, once trained, the domain-specific model 132 includes domain-specific parameters 134.

In some embodiments, the LLM Model Factory 112 trains a plurality of domain-specific model, each domain-specific model trained based on one of the domains 104a-e. In some embodiments, the training of the plurality of domain-specific models results in a domain-specific model for each domain 104a-e that was used to train the domain-neutral model 108.

In some embodiments, once trained, the domain-specific LLM detects new information in an input document.

In some embodiments, the domain-specific model 132 is configured to provide an estimate for a specific domain, such as a firm or company, of prior beliefs that can be used to compute a measure of information, such as high-surprisal information. In some embodiments, high-surprisal information is content having a low probability of occurring given a context. A domain-specific model 132 is trained to estimate such prior beliefs by being initialized with domain-neutral parameters 110 of the domain-neutral model 108 and being trained on the target domain 138 (e.g., fine-tuning).

In some embodiments, a separate domain-specific model 132 can be generated for each domain 104a-e illustrated by FIG. 1A. The set of domains (e.g., firms) can be indexed by F=1, 2, . . . , p. The set of indices associated with disclosures in the domain f before time t can be represented by J_{f,t}. The firm-specific information set at time t for firm f can be approximated by \hat{Ω}_{f,t}={ [symbol] ⱼ|∈J_{f,t}}. Each domain-specific model 132 can then obtain a domain-specific estimate of prior beliefs by determining a θ_{f,t} to minimize Equation 5 computed over the disclosures indexed by J_{f,t}. In some embodiments, when p domain-specific models 132 have been trained, each domain-specific model 132 can generate a respective estimate, resulting in p domain-specific estimates of prior beliefs.

In some embodiments, fine-tuning begins with initializing parameters of the domain-specific model 132 (e.g., the neural network weights) to be the optimized domain-neutral parameters θ 110 from the domain-neutral model 108. In some embodiments, an early-stopping method can be used to determine when to stop fine-tuning the domain-specific model 132. In some embodiments, the objective is evaluated using a validation sample after each epoch. In some embodiments, the training is stopped when the evaluated objective quantity ceases to decrease for three epochs. Once trained, the domain-specific model 132 can provide estimates of a domain-specific prior belief \hat{p}_{Ω}_{_{f,t}}(⋅;θ_{f}) based on the narrative disclosure.

Uncovering High Suprisal Information with a Domain-Specific Model

FIG. 1C is a block diagram 160 of the domain-specific model 132 determining a surprise value 170. In some embodiments, the domain-specific model 132 is configured to generate a surprise value 170 based on input text of an input document. In some embodiments, the surprise value can be a surprise metric, a measure of high-surprisal information, a measure of new information, or a likelihood that all or part of an input document includes new information. In some embodiments, the input text is in the form of an ordered sequence of tokens 162. In some embodiments, the ordered sequence of tokens 162 includes preceding tokens 164, a given token 166, and subsequent tokens 168. In some embodiments, such as when the given token 166 is a first token of the ordered sequence of tokens 162, there are no preceding tokens 164. In some embodiments, such as when the given token 166 is the last token of the ordered sequence of tokens 162, there are no subsequent tokens 168.

In some embodiments, the domain-specific model 132 generates a probability distribution 172 of predicted token(s) based on the preceding tokens 164. In some embodiments, the probability distribution 172 can be data structure having the predicted token(s) and probabilities associated with each predicted token(s). The domain-specific model 132 can then compare the given token 166 to the predicted token(s) of the probability distribution 172 to determine a probability of occurrence of that given token 166. In some embodiments, a comparison model (not shown) compares the given token 166 to the predicted token(s) of the probability distribution 172 to determine a probability of occurrence of that given token. Based on the probability of an occurrence of that given token 166, the surprise value 170 is assigned to that given token 166. In some embodiments, the surprise value 170 identifies high-surprisal information. In some embodiments, the domain-specific model 132 performs this analysis for each given token 166 and preceding tokens 164 of the ordered sequence of tokens 162.

In some embodiments, the domain-specific model 132 provides a surprise value 170 that surfaces high-surprisal information (e.g., identifying new information, unexpected information).

In some embodiments, the domain-specific model 132, which are tailored to a target domain 138 (e.g., a firm, a company, an enterprise, an entity, a domain, etc.), determine when a token, word, sentence, paragraph in a document in the target domain contains high-surprisal information using the surprise value 170. In some embodiments, the domain-specific model 132 disclosed herein surface high-surprisal information that has not been communicated previously (e.g., via the probability distribution 172 and surprise value 170).

In some embodiments, the domain-specific model 132 generates a summary measure of the amount of information released in each document. In some embodiments, the summary measure is a combination of the surprise value 170 determined for each token of the ordered sequence of tokens 162.

Identifying new, high-surprisal, or surprising information can be useful and have applications in many domains. In some embodiments, a domain-specific model 132 is trained and configured to surface (e.g., uncovering) high-surprisal information in any domain or topic. In some embodiments, the domain-specific model 132 is trained to surface high-surprisal information in the domain of financial reporting documents.

In some embodiments, a quantification of measuring information can be used when determining whether documents contain new information. In a financial domain, a disclosure can be considered informative to the extent that it updates beliefs about prior beliefs about a company, firm, corporation, etc., such as its cash flows or risks associated with these cash flows. When considering numerical disclosures (e.g., numbers in financial statements), such a measure can be the difference between realized and expected earnings. However, this measure may not apply to narrative disclosures because they are not numerical disclosures.

In some embodiments, a domain-specific model 132 can provide surprise value 170 that is a measure of narrative new information (e.g., new information, high-surprisal information, surprise information) in an input document compared to a corpus of documents. Such a measure can be valuable because the narrative portion of a document is often larger the numerical portion of the document. In some embodiments, surfacing new information of a large document using the domain-specific models 132 analyzes the words, sentences, and their broader context both within the document and within the history of disclosures that came before it.

In alternative methods, dictionaries of words relevant to a single construct of interest (e.g., sentiment, or litigation risk, etc.). In these alternative methods, disclosure is measured along one of these single factors using a count of words in the dictionary. This alternative method is limited because it relies on a subjective vocabulary of relevant terms, rather than learning them directly from data. This alternative method is further limited because the meaning of a word or phrase typically depends on how it is used in the sentence, which dictionaries cannot capture. For example, finding a word that belongs to a dictionary does not determine whether the information has been communicated earlier. Given these limitations of this alternative method, a different approach to detect new information is needed.

A document or portion of a document can be considered informative when it updates the reader's existing beliefs or provides new information compared to an existing corpus of documents. One calculation for a measure of new information in a text can be the sum of the probabilities (e.g., log probabilities) of each token (e.g., sub-word or a word) conditioned on the preceding context (e.g., preceding tokens, prior tokens). This measure of new information can provide flexibility by capturing information at the sub-word, word, sentence, paragraph, section, or document levels. This measure can therefore determine a location in a document of new information.

In some embodiments, the domain-specific model 132 calculates the probability that a word will appear in a text. In some embodiments, the domain-specific model 132 can estimate a probability distribution 172 of the words or tokens that can occur, conditional on the preceding tokens 164. In some embodiments, the domain-specific model 132 can be configured as a large language models (LLMs) to calculate the probability or probability distribution. In some embodiments, a domain-specific model is trained based on a target domain.

In some embodiments, the domain-specific model can be used by, given a disclosure [symbol] produced by a domain f, applying the domain-specific prior to quantify the information of the i-th token:

$$I ( {τ}_{i} ) = - log {\hat{p}}_{{Ω}_{t}} ( {τ}_{i} \vert {τ}_{i - 1} , … , {τ}_{i - k} ; {θ}_{f} ) . \qquad ( 6 )$$

This approach can identify the location of comparatively more informative tokens with a high degree of precision.

In some embodiments, a method of training and using a domain-specific model 132 uncovers high-surprisal information within unstructured textual data (e.g., narrative disclosures). In some embodiments, the domain-specific model 132 is trained to form priors over narrative content, which can then be used to identify information in new content.

In some embodiments, domain(s) 104a-e can be related to business, accounting, and finance. For example, the domains 104a-e can each be a publicly-traded company. In some embodiments, the present disclosure can be applied in fields other than business, accounting, and finance.

In some embodiments, the corpus of documents 102 are finance-related disclosures from a company. In some embodiments, each domain 104a-e is a company, and the documents 106 associated with the domain are that company's financially related disclosures (e.g., publically available disclosures). In some embodiments, the target domain 138 of FIG. 1B is a company that is represented by the multiple domains 104a-e. In some embodiments, the target domain 138 of FIG. 1B is not included in the multiple domains 104a-e.

In some embodiments, in a financial domain, the corpus of documents 102 of FIG. 1A includes SEC disclosures available on its Electronic Data Gathering, Analysis, and Review (EDGAR) system, such as Forms 10-K, 8-K, and 10-Q. In some embodiments, the documents are associated with or tagged with a timestamp or time of creation meatadata field. In some embodiments, the documents are tagged with a form-type (e.g., 10-K, 8-K, or 10-Q). In some embodiments, a measure of information can be caluclated for each form type. In some embodiments, a measure of information can be calculated for locations within each filing.

In alternative methods, year-over-year changes in the text of 10-Ks are compared. Specifically, these alternative methods directly measure the similarity of text across these documents as a measure of informativeness. These alternative methods of measuring similarity, however, do not determine whether there is new information because they only consider similarity across a document, but do not consider all information that has been released before the new disclosure.

In contrast, in some embodiments, the present domain-specific model 132 of FIGS. 1B-C provides a surprise value 170 that measures novel information in a given token 166 of an input document, compared to the corpus of documents 102, considering all preceding tokens 164 of the document.

### High-Surprisal Information

In some embodiments, information content analyzes numeric or quantitative information, such as stock prices or earnings, using surprise, a surprise value, or a surprise metric to quantify an amount of new information. A surprise, surprise value, or surprise metric can be a difference between the realization of a random variable and its expectation. Equation 1, below, is an example of a definition of surprise:

$${s}_{t + 1} = {x}_{t + 1} - 𝔼 [ {\tilde{x}}_{t + 1} \vert {Ω}_{t} ] . \qquad ( 1 )$$

where sₜ₊₁ is a surprise value measured at time t+1, \tilde{x}ₜ is a quantitative variable to be measured at time t, Ωₜ is a set of publicly available information at time t, and [symbol] [a|b] is the expectation of a given b. Examples of the quantitative variable include net income, stock price, fraction of negative words in news stories about a company or industry, fraction of litigious words in a company's 10-K etc.

In some embodiments, measuring an amount of new information in textual communications (e.g., a surprise value) presents challenges compared to numerical or quantitative surprise values. First, narrative information (e.g., unstructured text data) is multidimensional, and therefore a surprise value is challenging to implement directly. Second, it is difficult to calculate expected values for unstructured textual data.

In alternative approaches, similarity between documents (e.g., annual reports) has been assessed between documents from a first specific period to a second specific period based on bag-of-words representation. In other alternative approaches, only the immediately prior period's document are used as a proxy for expected sentiment when comparing to the current period's document.

These alternative approaches do not identify new information or high-surprisal information. Instead, these alternative approaches only find differences in the filing relative to the prior period's filing, and ignore all other past documents. These alternative approaches are not useful for identifying and processing new information in its own right. For example, detecting a lack of similarity does not imply the presence of new information. For example, removing irrelevant text from an older document affects a similarity metric of these alternative approaches in the same way as adding new information to the current document. Further, these alternative approaches require two documents that are consecutive in time and of the same type, and cannot be easily adapted to compare annual and quarterly reports due to their different nature and level of detail. In these alternate approaches, other disclosures of a different type or disclosures that are not immediately preceding the disclosure being examined may have already communicated the information, and would be undetected new information.

In some embodiments, a surprise value for determining or surfacing new or high-surprisal information in a document is based on a probability that the message is expected to be received by the recipient. The information content of the message can be considered a component that was previously unknown to the receiver. For example, if the entire message was known to the receiver a priori (e.g., the message was expected to be received with probability one), then the information content is zero. Therefore, the information content can depend not only on the message but also on the receiver's expectations about the message. Equation 2, below, expresses that the information content of a message can be expressed as follows:

$$I ( x ) = - log p ( x ) \qquad ( 2 )$$

where p(⋅) is the probability density function of x.

In some embodiments, the notion of information content, sometimes referred to as self-information, is linked to the notion of a surprise value described in relation to Equation 1. To illustrate this relation, consider a continuous random variable \tilde{x} that follows a Gaussian distribution. Substituting the density of \tilde{x} into Equation 2 yields the following relation for the information contained in a given realization x:

$$I ( x ) ∝ {( x - 𝔼 ( \tilde{x} ) )}^{2} . \qquad ( 3 )$$

In some embodiments, Equation 1 signs the surprise in observing a realization x, but Equation 2 does not sign the surprise. In other words, Equation 2 does not express the sentiment of the surprise, only its magnitude, but otherwise retains its intuitive and desirable properties. In some embodiments, \tilde{x}˜ [symbol] (μ,σ²) and other tractable and intuitive forms of the information content can be derived for members of the exponential family of distributions, such as the Gaussian distribution.

In some embodiments, any textual disclosure [symbol] can be represented as a sequence of random variables (tokens), [symbol] ={\tilde{τ}₁, . . . , \tilde{τ}ₙ}, which follow a joint probability distribution \hat{p}_{Ω}_{ₜ} (⋅). These tokens can include sub-words, words in a sentence, phrases in a sentence, groups of words, sentences in a document, or paragraphs in a document. The information in a realized disclosure [symbol] can be given by:

$$\begin{matrix}{I}_{t} ( 𝒟 ) = - log {p}_{{Ω}_{t}} ( {τ}_{1} , … , {τ}_{n} ) \\ = - log {\prod }_{i = 2}^{n} {p}_{{Ω}_{t}} ( {τ}_{i} \vert {τ}_{i - 1} , … , {τ}_{1} ) , \\ = - {\sum }_{i = 2}^{n} log {p}_{{Ω}_{t}} ( {τ}_{i} \vert {τ}_{i - 1} , … , {τ}_{1} ) - log {p}_{{Ω}_{t}} ( {τ}_{1} ) ,\end{matrix} \qquad ( 4 )$$

where Ωₜ is a set of publicly available information. In some embodiments, the chain rule of conditional probabilities is employed. In some embodiments, the relationship expressed by Equation 4 measures the amount of new information in a text by summing the log probabilities of each word (e.g., token) conditional on the preceding words (e.g., tokens). In some embodiments, the domain-neutral model and domain-specific model(s) are configured to model these conditional probabilities.

In some embodiments, the information metric of Equation 4 is causal because the probability of a given token in an ordered sequence of tokens depends on the context of the tokens preceding the given token. In some embodiments, the joint distribution is based on the tokens of the ordered sequence of tokens to the succeeding of a given token, such as p( [symbol] )=p(τₙ)p(τₙ₋₁|τₙ)× . . . ×p(τ₁|τ₂, . . . , τₙ).

### Model and Corpus of Documents Configurations

In some embodiments, a large language model estimates p_{Ω}_{ₜ}(⋅) from a corpus of documents available at time t. In some embodiments, the large language model is a GPT larguage language model.

In some embodiments, the amount of computation associated with executing this sequence of tasks can be a function of two choices: the LLM size and the number of domains in the sample. In some embodiments, selecting the number of parameters for the LLM (e.g., the LLM size) is based on one or more of the volume of training data, computation budget (e.g., computing available, cloud computing available), and the capacity of the LLM to model the distributional properties of narrative disclosure. In some embodiments, the volume of training data and computation budget are fixed, and therefore the capacity of the LLM to model the distributional properties of narrative disclosure is the main feature by which to modify the LLM size. Model size can have decreasing returns to scale (e.g., the benefits from using larger and larger models become relatively small). In some embodiments, doubling the model size from 345 million parameters to 762 million reduces perplexity (e.g., a measure of how well a probability model fits a sample) by 30.3%, while further doubling the model size from 762 million parameters to 1.54 billion reduces perplexity by just 14.4%. While some larger LLMs can generating text that humans resembling that of a human author, the LLMs of embodiments of the present disclosure can model the distributional properties narrative disclosures, and perplexity can measure this modeling. In some embodiments, the domain-specific models have about 750 million parameters. In some embodiments, the domain-neutral models have about 750 million parameters.

In some embodiments, computation costs can increase when additional domain-specific LLMs are trained and used. In some embodiments, a different domain-specific model can be trained for each domain of the multiple domains used to train the domain-neutral models. In such a case, as the number of domains increases, so can the number of domain-specific models that need to be trained and the volume of disclosures to be analyzed.

In some embodiments, computation costs can be moderated by drawing a random sample of firms stratified by decile of market capitalization. In some embodiments, in the financial example, the firms (e.g., domains) for training can be selected by first filtering for firms that filed either a 10-K or 10-Q on EDGAR during the year 2007. In some embodiments, in the financial example, firms can be filtered based on a requirement to have a valid link to Compustat and CRSP. In some embodiments, each firm is assigned to a market value decile based on their market value of equity as of the end of 2007. In some embodiments, 250 firms are sampled from each decile of market value for a total sample size of 2,500 firms. Table 1A presents the effects of these filters on the firms eligible to be included. Given this sample of firms, firm fundamentals are collected from Compustat, equity market data from CRSP, and intraday data from NYSE TAQ. Further, disclosures are collected from EDGAR. In some embodiments, all continuous variables are winsorized by year at the 1% level.

TABLE 1A
Sample Construction - Selection of Firms in Sample

| Criteria | N-firms |
|---|---|
| Firms that filed a 10-K/Q on EDGAR in 2007 | 8,996 |
| Requiring link to Compustat | 4,374 |
| Stratified sampling by firm size decile | 2,500 |
| Decile 0: [$0, $37] | 250 |
| Decile 1: ($37, $82] | 250 |
| Decile 2: ($82, $144] | 250 |
| Decile 3: ($144, $246] | 250 |
| Decile 4: ($246, $402] | 250 |
| Decile 5: ($402, $667] | 250 |
| Decile 6: ($667, $1,146] | 250 |
| Decile 7: ($1,146, $2,128] | 250 |
| Decile 8: ($2,128, $5,192] | 250 |
| Decile 9: ($5,192, >$5,192) | 250 |

In some embodiments, in a financial example, the corpus of documents includes Forms 8-K, 10-Q, and 10-K for three reasons. First, these three forms alone can be responsible for a considerable amount of all the narrative disclosure on EDGAR (e.g., 40% of all narrative disclosure on EDGAR, while the next 40% is spread across 17 form types and the remaining 20% is spread across 405 form types). Second, Forms 10-K/Q (annual and quarterly reports) can serve to provide stakeholders with a standardized set of content (e.g., items, at regular intervals) and this content is likely to contain new information. Third, while the 10-Ks/10-Qs can be prepared periodically, a purpose of Form 8-K (e.g., the current report) can be to inform stakeholders of material events on an ongoing basis (e.g., without waiting for a 10-K/Q to be filed). The SEC requires that firms disclose the event within four business days of its occurrence. The distribution of Forms 8-K, 10-Q, and 10-K filed by firms is illustrated in Table 1B.

TABLE 1B
Volume of Filings in Sample

| | Training: | Inference: |
|---|---|---|
| Final Sample of Filings | 1996-2006 | 2007-2022 |
| # of Form 10-K | 18,906 | 22,778 |
| # of Form 10-Q | 71,520 | 67,659 |
| # of Form 8-K | 142,542 | 245,993 |
| GB of narrative content | 22.8 | 40.1 |
| # of words (billions) | 3.67 | 6.20 |

In some embodiments, developing a surprise value is based on the corpus of documents, which can include a set of narrative disclosures (e.g., documents) in a plain text format. In some embodiments, in a financial example, the narrative disclosures are gathered from the SEC EDGAR database. Notably, EDGAR system can accept and disseminate a wide array of filings, ranging from lengthy annual reports (e.g., Form 10-K) to brief and standardized disclosures such as changes in beneficial ownership (e.g., Form 4). In some embodiments, the corpus could include all such disclosures on EDGAR. In some embodiments, the corpus includes documents having narrative disclosures (e.g., those that primarily contain length written-word content, those having unstructured textual data) measuring the information in narrative disclosures.

In some embodiments, the three most voluminous form types are the Current Report (e.g., Form 8-K), Quarterly Report (e.g., Form 10-Q), and Annual Report (e.g., Form 10-K), respectively. Table 2, below, presents the volume of narrative disclosure filed on the SEC's EDGAR system from 1996 through 2022 by form type for the 20 longest form types based on word count.

TABLE 2
Volume of Narrative Disclosure on SEC EDGAR

| | | Cumulative Percent |
|---|---|---|
| Form Type | N-words (millions) | of All Disclosure |
| 8-K | 8,223 | 14% |
| 10-Q | 7,979 | 28% |
| 10-K | 6,675 | 40% |
| 424B2 | 3,457 | 46% |
| 424B3 | 3,045 | 51% |
| DEF 14A | 2,918 | 57% |
| 6-K | 1,877 | 60% |
| S-4/A | 1,612 | 63% |
| 424B5 | 1,431 | 65% |
| 20-F | 1,419 | 68% |
| S-4 | 1,255 | 70% |
| S-3 | 1,007 | 72% |
| PRE 14A | 648 | 73% |
| 424B4 | 639 | 74% |
| S-3/A | 605 | 75% |
| S-1/A | 581 | 76% |
| DEFM14A | 556 | 77% |
| FWP | 541 | 78% |
| 10-K405 | 527 | 79% |
| S-8 | 517 | 80% |

In some embodiments, the domain-specific model 132 can be trained on documents from a target company. Such training can model beliefs over narrative content. This domain-specific model can be then used to identify new information that the target company communicates.

### Training and Inference Data

FIG. 2 is a data partition 200 of training data 202 used to train a cross-sectional model 206 and inference data 204 according to embodiments of the present disclosure. The data partition 200 includes Forms 8-K, 10-Q, and 10-K that are available on the SEC's EDGAR system. In some embodiments, the narrative content is extracted from a database (e.g., filings of selected form types from SEC's EDGAR). In some embodiments, each form type includes a main filing can also include one or more attachments. The main filing can follow a standardized format based upon templates provided by the SEC. Attachments can be formatted formats depending on the nature of the attachment, e.g., an asset purchase agreement, forecasts of future performance, etc. The main filings can have a file type of plain text or HTML. The attachments can have a variety of file types such as plain text, HTML, XML, PDFs, or Excel files. However, any text-based file type can be used.

In some embodiments, file types other than HTML and PDFs can have embedded content. For example, some files may embed images having textual information. In some embodiments, the textual data in the images is extracted using optical character recognition (OCR), for example.

The cross-sectional model 206 is trained based on training data 202 for multiple firms 208a-n. The training data 202, in this example, is narrative disclosures having timestamps from the years 1996-2006. However, in some embodiments, the training data 202 does not include time stamps. In some embodiments, the training data 202 is not bounded by timestamps.

In some embodiments, inference data 204 are other narrative disclosures. In some embodiments, the inference data 204 are documents having timestamps with the years 2007-2023. However, in some embodiments, the inference data 204 does not include time stamps. In some embodiments, the training data 204 is not bounded by timestamps.

The cross-sectional model 206 is further fine-tuned to have domain-specific models for the target domains of each of firms 208a-n. The cross-sectional model 206 can be a plurality of domain-specific models 208a-n. In some embodiments, the cross-sectional model 206 includes all of the domain-specific models 208a-n. In some embodiments, the cross-sectional model includes some, but not all, of the domain-specific models 208a-n.

In some embodiments, the domain-specific models 208a-n can be applied to domain-specific narrative disclosures 210a-n from 2007 through 2022. In some embodiments, in response to each narrative disclosure 210a-n, the domain-specific models 208a-n generate out-of-sample estimates of the information contained in each disclosure.

In some embodiments, a corpus of documents is generated by extracting narrative content from each form type. The extraction can generate a corpus of plain text documents that are structurally similar regardless of the source file type (e.g., plain text or HTML), or the time period when the form was filed (e.g., prior to widespread adoption of HTML-based filings). In some embodiments, a training sample includes disclosures from 1996-2006 that amount to 22.8 GB of narrative content containing 3.67 billion words. In some embodiments, the test sample includes disclosures from 2007-2022 with the total 40.1 GB of narrative content containing 6.20 billion words.

### Validating the Models

In some embodiments, the domain-specific model is a large language model that can generate text in response to an input prompt, such as an ordered sequence of tokens. In some embodiments, the domain-neutral model and domain-specific model a probability distribution of expected text given a prompt. In some embodiments, the probability distribution can be a probability of a next predicted token given preceding tokens in the ordered sequence of tokens.

Therefore, providing a prompt to the domain-neutral model 108 of FIG. 1A can cause the respective model(s) to generate text output based on the prompt. In some embodiments, the domain-neutral model 108 is provided text that is commonly found at the start of the business description in Form 10-K as the prompt. Table 3 presents this prompt, and Table 4 presents four examples of text generated by the domain-neutral model 108. Table 4 illustrates that domain-neutral 108 can generate reasonably coherent text spanning various industries and interleaving numbers and dates as a reader might expect.

TABLE 3
Examples of Disclosures Generated by the LLMs

Item 1. Business Description
Our principal operating activities consist of[. . .]

TABLE 4
Examples of Disclosures Generated by the LLMs

| Sample | Generated Text |
|---|---|
| 1 | [. . .]the design, development, manufacture, |
| | marketing and sale of digital radio systems. |
| | Our principal research and development |
| | resources are located in the United States, |
| | Belgium, Germany and Canada.[. . .] |
| 2 | [. . .]the production, storage, processing and |
| | sale of natural gas as well as associated |
| | operating, general, and administrative costs |
| | necessary to provide benefits to our customers |
| | and to operate our business, including |
| | our marketing of natural gas, storage and |
| | processing, gas gathering, and |
| | transportation services.[. . .] |
| 3 | [. . .]developing and marketing our proprietary |
| | drug delivery technologies, research and |
| | development of drug delivery technologies |
| | associated with drug compounds and other |
| | non-topharmaceutical products and the |
| | provision of related clinical, regulatory, |
| | manufacturing and other related services. |
| | For the year ended Dec. 31, 2004, |
| | revenues represented $13.4 million or |
| | 95% of our expenses.[. . .] |
| 4 | [. . .]the operation of our network infrastructure, |
| | including those related to our satellite |
| | service; data centers and communications |
| | facilities, including those located in Europe, |
| | Latin America and Canada; sales and |
| | marketing; and administrative activities.[. . .] |

In a similar testing example, the prompt of Table 3 is provided to the domain-specific model(s) 132 of FIG. 1B-C to generate text (e.g., sampling from the model using a beam search). Table 5 presents examples of generated text for each domains 104a-e (e.g., firms), where the domains represent the companies of Apple®, Cummins®, Pfizer®, and Weyco Group®. The generated text can be seen to be diverse and related to each respective domain. The generated text can be seen to reference relevant products, previous disclosures, terms of agreements with suppliers, and financial performance of the respective domains. For example, the text generated for Cummins accurately refers to a particular footnote of a previous disclosure. For Pfizer, its generated text references two drugs called Alond and Exubera. Exubera is a Pfizer drug that was withdrawn from the market due to low sales. Collectively, the richness of these prompts can be viewed as further evidence that the training results in domain-specific models that are reasonable models of the distributional properties of narrative disclosure.

TABLE 5
Examples of Disclosures Generated by the LLMs

| Firm | Generated Text |
|---|---|
| Apple | [. . .]the design, development, marketing and sale of personal computers and related |
| | software, the activities of which are conducted throughout the Company's operating |
| | segments. The Company's products consist of the Macintosh line of computers, related |
| | peripherals and services, and the Mac OS ® X operating system (the Macintosh). The |
| | Company sells its products worldwide through its online stores, its retail stores, its direct |
| | sales force, and third-party wholes[. . .] |
| Cummins | [. . .]the operations of our Engine Segment, which is described in Note 17 to the |
| | Consolidated Financial Statements included in our 2004 Annual Report on Form 10-K. |
| | The Engine Segment produces engines and parts for sale to customers in on-highway, |
| | commercial, institutional and mining applications. Our Power Generation Segment |
| | produces engines and parts for power generation equipment and is headquartered in |
| | Columbus, Indiana. We have manufacturing plants worldwide, including major |
| | operations[. . .] |
| Pfizer | [. . .]the discovery, development, manufacture, marketing and sale of prescription |
| | medicines for humans and animals as well as our over-the-counter products. |
| | We also purchase products from numerous suppliers. These purchases are generally |
| | made through various means including through our operating subsidiaries. Wherever |
| | possible, commercial relationships are maintained with our suppliers. Where possible, |
| | these relationships can be terminated early with 90 days' notice. We believe that we have |
| | good relationships with our suppliers. |
| | We made significant progress during 1999 in the development of our pharmaceutical |
| | products, manufacturing processes and commercialized products. We have successfully |
| | enhanced these systems and are implementing significant changes in our internal systems |
| | and processes including: |
| | Alond, a treatment for schizophrenia, was launched in September 1999 to |
| | increase capacity and efficiency in our manufacturing operations |
| | Exubera, our inhaled insulin medication for chronic obstructive[. . .] |
| Weyco | [. . .]the manufacture and sale of men's casual, dress and fashion footwear. The majority of |
| Group | foreign-sourced purchases are denominated in U.S. dollars. The Company also has a small |
| | number of retail stores in Europe and, accordingly, the Company's results are primarily |
| | impacted by the economic conditions and the retail environment in the United States. |
| | We have historically generated adequate cash flow from operations to meet working capital |
| | requirements. In 2003, cash flows from operations was $7.5 million, as compared to $6.7 |
| | million last year.[. . .] |

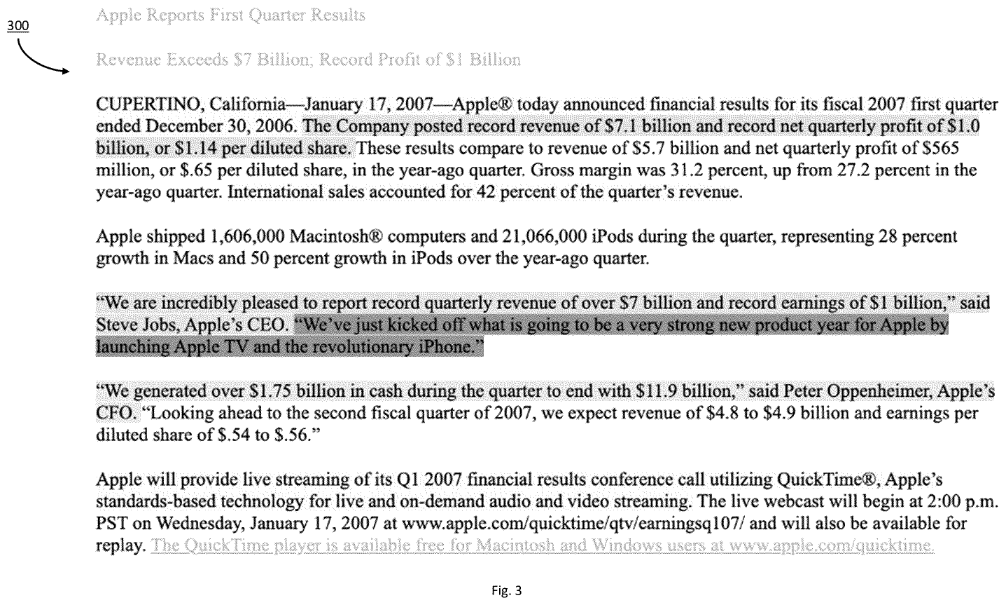

FIG. 3 is a representation of document 300 having variably highlighted sentences. In some embodiments, the domain-specific model 132 of FIGS. 1B-C can output a measure of high-surprisal information for a given prediction window. The prediction window can be a token, word, sentence, paragraph, or other size. The measure of high-surprisal information for the prediction window can combine the measures of high surprisal information (e.g., the surprise value 170 of FIG. 1C) for each token in the prediction window. In some embodiments, such as an embodiment illustrated by FIG. 3, the prediction window is a sentence.

In some embodiments, the shade of the highlighting of each prediction window is proportional to the combined measure of high-surprisal information. That combined measure of high-surprisal information can represent the domain-specific model's 132 estimate of new information in that prediction window. The estimate of new information can represent high-surprisal information relative to the training data 202 (e.g., Apple-specific prior of pre-2007 information).

In some embodiments and with reference to FIG. 3, the document being analyzed is an announcement dated Jan. 17, 2007, disclosed in Apple's 8-K filing, where the company first mentions the introduction of its iPhone. While the disclosure contains numerous pieces of information, such as record revenue, the sentence illustrated as having the most inforation—according to the estimated prior—is the sentence in which Apple mentions launching the iPhone and Apple TV.

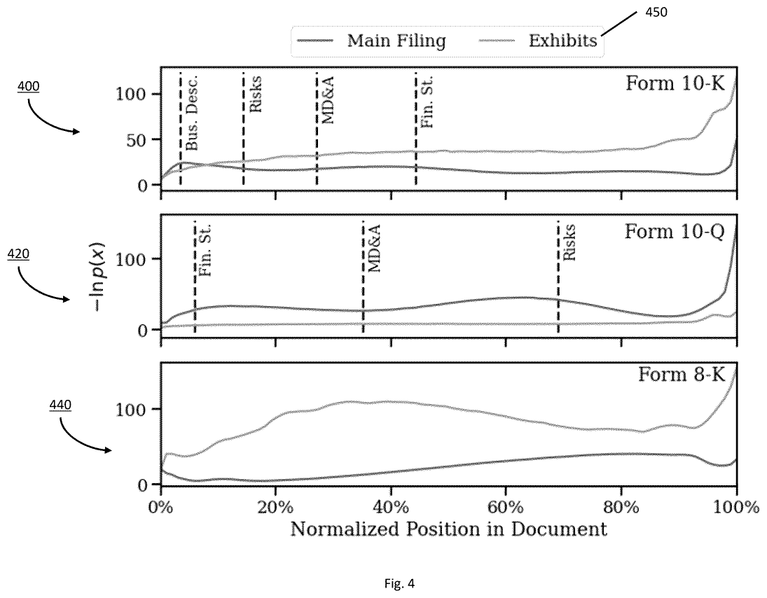

FIG. 4 are graphs 400, 420, and 440 representing an information metric as a function of position in the document. In some embodiments, the model can be validated by examining the location of information in 10-K, 10-Q, and 8-K filings uncovered by the surprise value in a financial example. For each filing, the body of the filing (e.g., the portion of the filing that generally follows a standardized format prescribed by the SEC) can be considered separately from exhibits. In some embodiments, the token-by-token information is computed using the respective prior. In some embodiments, the position of each token is normalized in the filing such that the first token corresponds to a position marked by 0%, and the last token corresponds to 100%.

In some embodiments, a geometric mean of the measure of high-surprisal information can be calculated within each percent increment of the document (e.g., [0%, 1%], [1%, 2%], . . . , [99%, 100%]). In some embodiments, other increments can be used to calculate the geometric mean of the surprise value. In some embodiments, when a given filing has multiple exhibits, then the exhibits can be combined by computing the arithmetic mean of the measure of high-surprisal information for each percentage increment across exhibits, weighted by the length of each exhibit. In some embodiments, the means are then averaged across all filings to determine common locations in each document time that contain high-surprisal information.

Each respective graph 400, 420, and 440 illustrates the main filing and exhibits with separate lines, as indicated by the legend 450. The graph 400 representing 10-K filings and the graph 440 representing 8-K filings illustrate that exhibits can be more informative than the main filing. However, the graph 420 representing the 10-Q filings illustrates that the main filings can be more informative than the exhibits. Across all filing types, the graphs 400, 420, and 440 illustrate that high-surprisal information can spike toward the end of the filing. In some cases, for 10-K/Q filings, the high-surprisal information spike may be driven by footnotes or endnotes. For 8-K forms, graph 440 illustrates that the high-surprisal information spike can be largest in the exhibits. In some cases, this may be because firms provide boilerplate information in the beginning of documents, (e.g., caveats to forward-looking statements) followed by more detailed information at the end of the documents (e.g., a discussion of new business strategies).

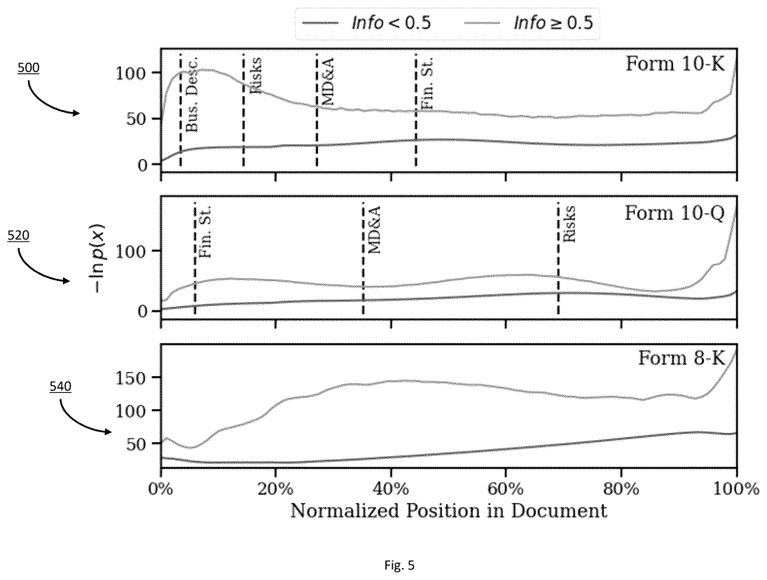

FIG. 5 are graphs 500, 520, and 540 representing whether the average high-surprisal information in a filing is above or below the median as a function of normalized position in the document. The graph 540 of 8-K filings illustrates results similar to those in graph 440 of FIG. 4. However, in some embodiments, the graph 500 of 10-K filings indicates that firms discuss new information early on.

Table 6 presents an example distribution of the information measure separately for the set of main filings and exhibits in the sample. For a given main filing, the filing's information can be computed as the geometric mean of the token-by-token measurements of high-surprisal information. For a set of exhibits attached to a given filing, the exhibit's information can be computed as the geometric mean of the token-by-token measurements, and the arithmetic mean can be computed across all exhibits weighted by the length of each exhibit.

| | Distribution of Information | | | | | |
|---|---|---|---|---|---|---|
| | Annual Report | | Quarterly Report | | Current Report | |
| | (Form 10-K) | | (Form 10-Q) | | (Form 8-K) | |
| | Main | Exhibits | Main | Exhibits | Main | Exhibits |
| Mean | 14.60 | 9.54 | 16.83 | 5.19 | 7.15 | 35.64 |
| Percentiles | | | | | | |
| 1-st | 2.60 | 1.03 | 2.31 | 1.00 | 1.05 | 1.18 |
| 5-th | 3.21 | 1.10 | 3.09 | 1.00 | 1.11 | 1.55 |
| 25-th | 4.55 | 1.33 | 4.99 | 1.06 | 1.39 | 3.99 |
| 50-th | 6.10 | 2.29 | 7.11 | 1.16 | 2.21 | 10.45 |
| 75-th | 8.96 | 6.46 | 10.47 | 2.06 | 6.53 | 27.15 |
| 95-th | 15.61 | 20.33 | 17.39 | 8.18 | 18.36 | 63.68 |
| 99-th | 209.92 | 97.04 | 212.10 | 69.62 | 62.55 | 406.41 |

In some embodiments, a short-window daily event can examine whether the quantity of textual information measured can explain market reaction to disclosures. If the measure of high-surprisal information indicates the surfacing of new information, it can be expected to see a more pronounced market reaction around the disclosure date when the measure suggests a higher information content.

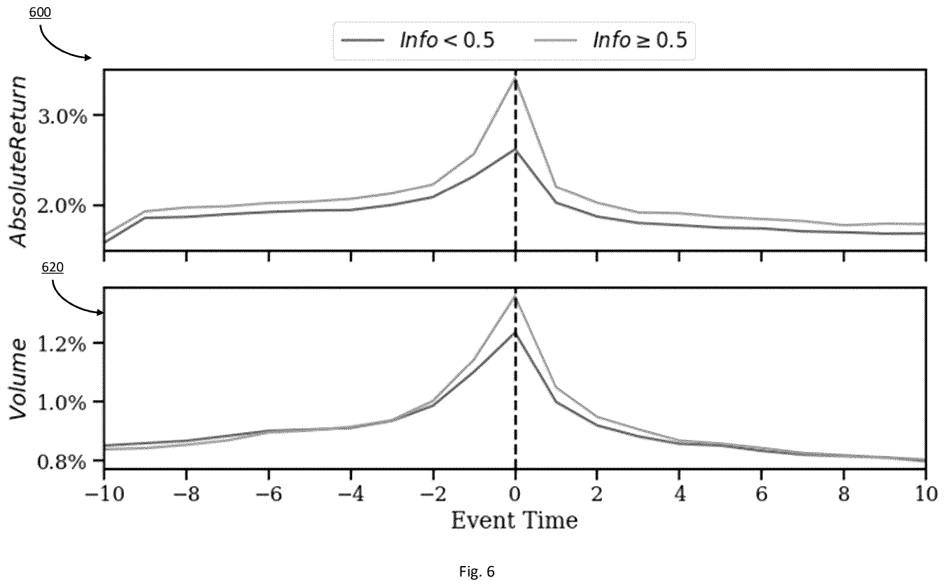

FIG. 6 are graphs 600 and 620 representing average daily values of AbsoluteReturn in graph 600 and Volume in graph 620 for the [−10, 10] day window around the filing date separately for filings that are above and below median info—the measure of amount of high-surprisal information in the textual disclosures over the entire document. FIG. 6 represents the info metric for annual and quarterly reports.

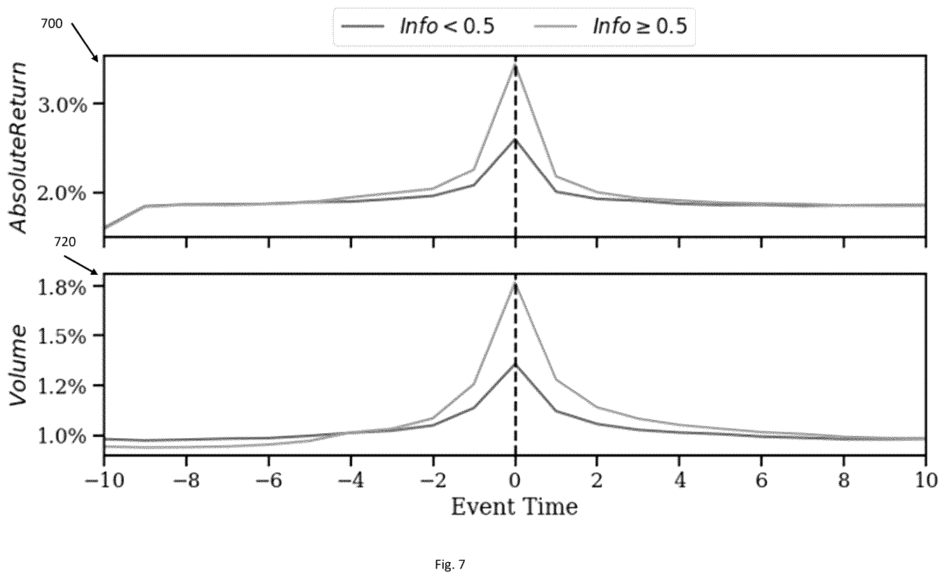

FIG. 7 are graphs 700 and 720 representing average daily values of AbsoluteReturn in graph 700 and Volume in graph 720 for the [−10, 10] day window around the filing date separately for filings that are above and below median info—the measure of amount of high-surprisal information in the textual disclosures over the entire document. FIG. 7 represents the info based on current reports (8-Ks).

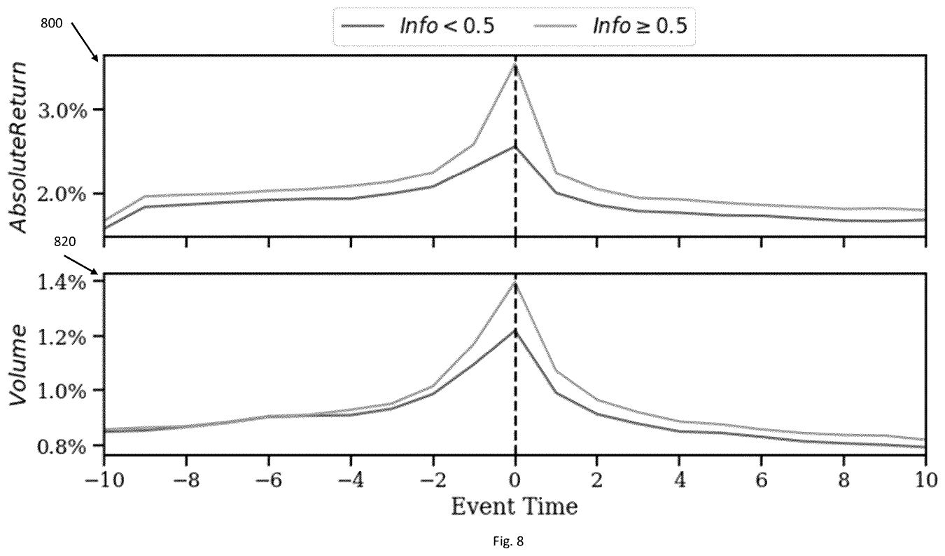

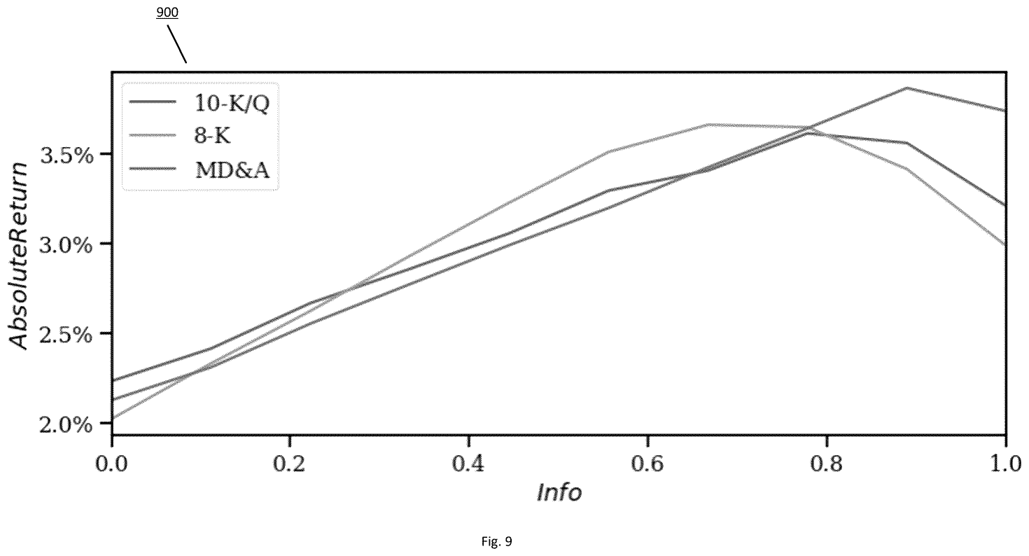

FIG. 8 are graphs 800 and 820 representing average daily values of AbsoluteReturn in graph 800 and Volume in graph 820 for the [−10, 10] day window around the filing date separately for filings that are above and below median info—the measure of amount of new information in the textual disclosures over the entire document. FIG. 8 represents the info based the narrative content of the Management's Discussion and Analysis.

In some embodiments, the graphs of FIGS. 6-8 illustrate that there can be an increase in the absolute return and volume of a stock on the filing date. The graphs further illustrate that the increase can be larger when the filing includes above an median Info disclosure.

FIG. 9 is a graph 900 plotting the average value of AbsoluteReturn for t=0 as a function of Info. The market reaction on the disclosure day can be expected to increase when the measure of information is higher. Graph 900 illustrates that absolute return increases as a function of the Info metric, with the exception of the most extreme deciles.

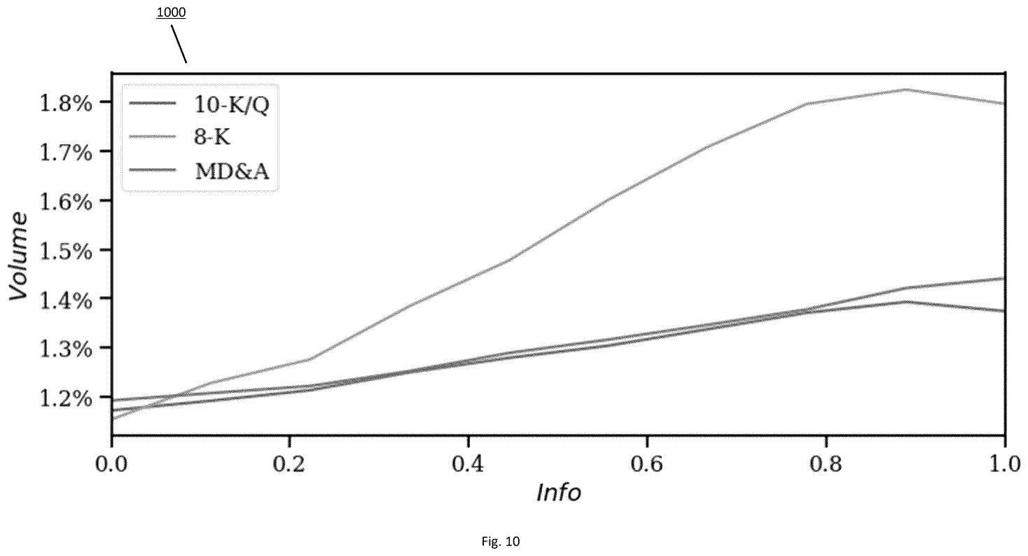

FIG. 10 is a graph 1000 plotting the average value of AbsoluteReturn for t=0 as a function of Info. It can be expected that the market reaction on the disclosure day increases more when the measure of information is higher. Graph 1000 illustrates that absolute return increases as a function of the Info metric, with the exception of the most extreme deciles.

FIGS. 9-10 illustrate that that both measures of market reaction can correlate with increasing functions of Info, with the exception of the most extreme deciles.

To test whether there is a statistically significant relation between Info and the market reaction, Equation 7 can be an estimate of regression pooling across all firm-dates in the [−10, 10] day window around the filing date:

$${y}_{f , t} = {β}_{1} Event [ 0 ] + {β}_{2} Event [ 0 ] \times {Info}_{f , j} + γ {X}_{f , t} + {δ}_{t} + {λ}_{f , t} + {ϵ}_{f , t} \qquad ( 7 )$$

where y_{f,t} is either AbsoluteReturn or Volume, for firm f on date t. Event[0] can represent an indicator variable equal to one on the first date that the market could react to the filing and zero otherwise. The first date the market could react can be the filing date for filings accepted either prior to markets opening or intraday and the date of the following trading session whereas for filings accepted after markets close. Info_{f,t} can represent the measure of the information contained in the j-th disclosure filed by firm f. A benchmark model can also proxy for information content with document Length, which is the count of characters in the narrative content in the filing deciled and scaled to range from zero to one. X_{f,t} can be a vector of control variables for firm f on date t. δₜ can be a date fixed effect. λ_{f,t} can be a firm fixed effect for the 10-K/Q sample and a firm-year-quarter fixed effect for the 8-K sample. β₁ and β₂ are coefficients of interest. β₁ can represent the average market reaction to filings in the lowest decile of Info while β₂ represents the incremental market reaction associated with moving from the lowest to highest decile of Info. Regressions can be estimated using OLS. Standard errors can be reported clustered by firm and independently by date, which can allow for arbitrary correlation across time within a given firm and across firms within a given date.

Table 7 presents example descriptive statistics for the variables used in the daily event study partitioned by above and below median Info. Table 7 illustrates that firms with high Info disclosures may not be systematically different (e.g., of the 17 variables considered none are significantly different between groups at the one percent level). Notably, firms in the high Info group can tend to be slightly more leveraged (Leverage of 0.585 versus 0.564 and significant at the five percent level). AbsoluteReturn can be the absolute value of the daily residual from an expected returns model estimated over a [−70,−11] window relative to the event, expressed as a percent. Volume can be the ratio of daily volume of shares traded to shares outstanding, expressed as a percent. AbnormalReturn can be the daily residual from the expected returns model estimated over the [−70,−11] window relative to the event, expressed as a percent. AdExp can be the ratio of advertising expense to sales. CapEx can be the ratio of capital expenditures to total assets. CapIntens can be the ratio of property, plant, and equipment to total assets. CorpAcq can be an indicator variable equal to one if an acquisition accounts for at least 20% of sales. Financing can be the sum of equity and debt issuances over the fiscal quarter scaled by total assets. IdioVol can be the standard deviation of the residual from a six-factor expected returns model using the daily returns over the prior fiscal quarter expressed as a percent. Leverage can be the natural logarithm of the sum of long-term debt and debt in current liabilities scaled by total assets. MTB can be the ratio of market to book value of equity. R&D can be the ratio of research and development expense to sales. QtrlyReturn can be the buy and hold return over the fiscal quarter expressed as a percent. ShortTermReturn can be the buy and hold return during the window [t−5, t−1] for each date t expressed as a percent. ShortTermVolat can be the daily stock return volatility during the window [t−5, t−1] for each date t expressed as a percent. Size can be the natural logarithm of total assets. SpecItems can be special items scaled market value of equity. The star symbols ***, **, and * can denote statistical significance at the 0.01, 0.05, and 0.10 levels (e.g., two-tail) based on standard errors clustered by firm and date, respectively.

TABLE 7
Daily Event Study Descriptive Statistics

| | Low Info Group | | High Info Group | |
|---|---|---|---|---|
| | (Info < 0.5) | | (Info ≥ 0.5) | |
| Variable | Mean | Median | Mean | Median |
| AbsoluteReturn | 2.031 | 1.141 | 2.090 | 1.157 |
| Volume | 1.107 | 0.645 | 1.215 | 0.655 |
| AbnormalReturn | −0.007 | −0.049 | 0.000 | −0.050 |
| AdExp | 0.093 | 0.003 | 0.084 | 0.004 |
| CapEx | 0.026 | 0.014 | 0.026 | 0.013 |
| CapIntens | 0.256 | 0.165 | 0.243 | 0.152 |
| CorpAcq | 0.180 | 0.000 | 0.191 | 0.000 |
| Financing | 0.084 | 0.010 | 0.088 | 0.012 |
| IdioVol | 2.321 | 1.784 | 2.328 | 1.789 |
| Leverage | 0.564 | 0.548 | 0.585** | 0.570** |
| MTB | 1.914 | 1.451 | 1.850 | 1.400 |
| QtrlyReturn | 3.479 | 2.100 | 3.145** | 1.821 |
| RØD | 1.575 | 0.000 | 1.754 | 0.000 |
| ShortTermReturn | 0.261 | 0.116 | 0.301 | 0.111 |
| ShortTermVolat | 0.168 | 0.039 | 0.191 | 0.040 |
| Size | 7.082 | 7.156 | 7.182* | 7.270* |
| SpecItems | −0.455 | 0.000 | −0.887 | 0.000 |

Table 8A presents example results from estimating Equation 7 for annual reports, and Table 8B presents example results for estimating Equation 7 for quarterly reports. In the examples analyzed by Tables 8A-B, across all measures and form types, there is evidence of statistically and economically significant market reactions on the disclosure event day. For example, estimates of β₁ for AbsoluteReturn range from 0.465 to 1.190 with t-stats ranging from 12.17 to 18.08. These estimates can represent an economically significant 22.8% to 58.6% increase in AbsoluteReturn relative to the sample mean. Moving from the lowest to the highest decile of Info measure can be associated with a highly statistically and economically significant market reaction. For example, columns (3) and (6) in Table 8B indicate the corresponding 71.4% and 143% increases in AbsoluteReturn and Volume, respectively. Further, estimates of β₁ can shrink considerably, such as in columns (3) and (6)) because they represent just 23.0% and 33.0% increases, respectively, versus 58.6% and 104% in columns (1) and (4), respectively. In contrast, examining the Length benchmark as a measure of information, results can be inconsistent (t-stats range from −1.853 to 4.283).

TABLE 8A
Market Reaction based on Annual Reports

| | Dependent Variable: | | | Dependent Variable: | | |
|---|---|---|---|---|---|---|
| Independent | AbsoluteReturn | | | Volume | | |
| Variable | (1) | (2) | (3) | (4) | (5) | (6) |
| Event[0] | 0.989*** | 1.062*** | 0.511*** | 0.392*** | 0.316*** | 0.279*** |
| | (13.183) | (18.075) | (11.823) | (13.436) | (6.626) | (7.839) |
| Event[0] × Length | | −0.156* | | | 0.155** | |
| | | (−1.853) | | | (2.319) | |
| Event[0] × Info | | | 1.151*** | | | 0.271*** |
| | | | (19.897) | | | (4.295) |
| Daily Controls | Y | Y | Y | Y | Y | Y |
| Quarterly Controls | Y | Y | Y | Y | Y | Y |
| Date FEs | Y | Y | Y | Y | Y | Y |
| Firm FEs | Y | Y | Y | Y | Y | Y |
| N-obs | 2,204,716 | 2,204,716 | 2,204,716 | 2,204,716 | 2,204,716 | 2,204,716 |
| N-firms | 2,460 | 2,460 | 2,460 | 2,460 | 2,460 | 2,460 |

TABLE 8B
Market Reaction based on Annual Reports

| | Dependent Variable: | | | Dependent Variable: | | |
|---|---|---|---|---|---|---|
| Independent | AbsoluteReturn | | | Volume | | |
| Variable | (1) | (2) | (3) | (4) | (5) | (6) |
| Event[0] | 1.190*** | 1.147*** | 0.465*** | 0.684*** | 0.658*** | 0.216*** |
| | (12.172) | (12.604) | (17.357) | (10.873) | (10.623) | (3.064) |
| Event[0] × Length | | 0.246*** | | | 0.153 | |
| | | (4.283) | | | (1.519) | |
| Event[0] × Info | | | 1.450*** | | | 0.939*** |
| | | | (13.597) | | | (8.343) |
| Daily Controls | Y | Y | Y | Y | Y | Y |
| Date FEs | Y | Y | Y | Y | Y | Y |
| Firm-Year-Qtr FEs | Y | Y | Y | Y | Y | Y |
| N-obs | 5,918,652 | 5,918,652 | 5,918,652 | 5,918,652 | 5,918,652 | 5,918,652 |
| N-firms | 2,499 | 2,499 | 2,499 | 2,499 | 2,499 | 2,499 |

The magnitude of the difference of β₂ relative to β₁ can be interpreted as the proportion of the market reaction explained by the information in narrative content. For example, if the information measure had no error rate and the information in narrative content was responsible for 90% of the market reaction to the announcement, then β₂ is expected to be roughly nine times larger than 1. In an example with an imperfect measure of textual information content, however, β₁ can be expected to absorb a portion of the market reaction attributable to narrative content. In this example, the magnitude of β₂ relative to β₁ puts a lower bound on the portion of the market reaction attributable to information in narrative content. Across three of four specifications (Columns (3) and (6) in Tables 8A-B), β₂ is two to four times larger than β₁. These results are consistent with the notion that the market reaction can be primarily explained by the information provided in narrative content.

In another test example, the market reaction can be examined relative to the sentiment of the filing depends on the disclosed textual information content. In alternative methods, the sentiment of disclosure alone explains returns only to the extent it is associated with the revelation of information. For example, a negative sentiment of an Management's Discussion and Analysis (MD&A) is unlikely to trigger market reactions if the same information had previously been communicated in the prior press release. Therefore, an interaction between sentiment and information may explain stock returns upon the announcement.

In some embodiments, sentiment can be measured using negative and positive dictionaries. For each word in a disclosure, the sentiment is signed as negative one, one, or zero based on whether the word occurs in the negative dictionary, positive dictionary, or neither. In some embodiments, this signed sentiment is called FinNeg. FinNeg can then be combined with the information measured in Equation 6. Given this token-by-token interaction between sentiment and information, a parallel approached used to calculate Info can be employed. In some embodiments, the geometric mean is calculated over the disclosure, the measure is sorted into deciles, and the measure is scaled to range from minus one to one. The resulting variable Info×FinNeg can be signed information or information-weighted sentiment.

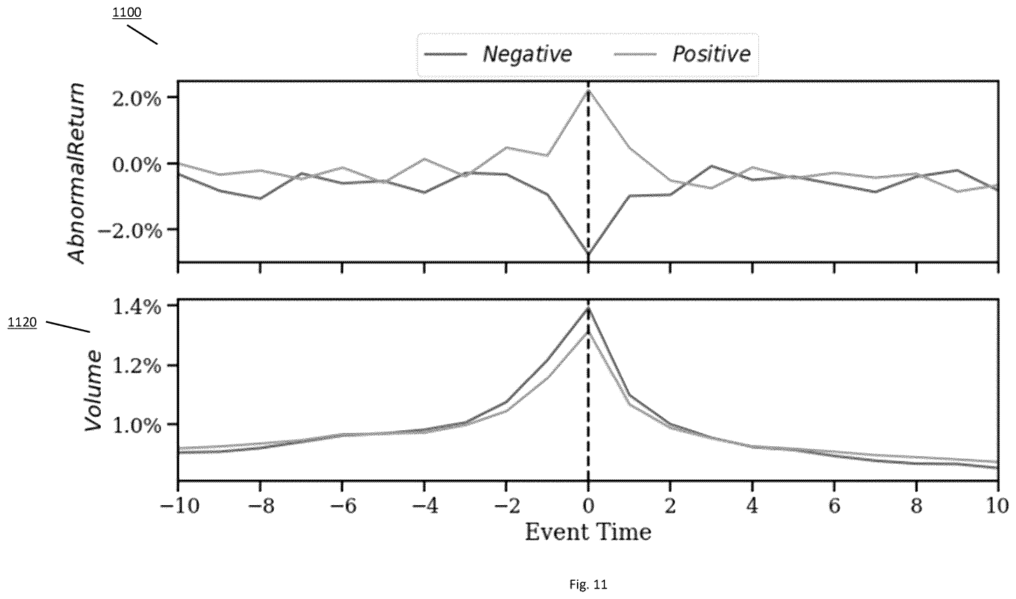

FIG. 11 are graphs 1100 and 1120 plotting example average daily values of AbnormalReturn and Volume in the [−10, 10] day window around the filing date separately for filings that are above and below median Info×FinNeg for annual and quarterly reports.

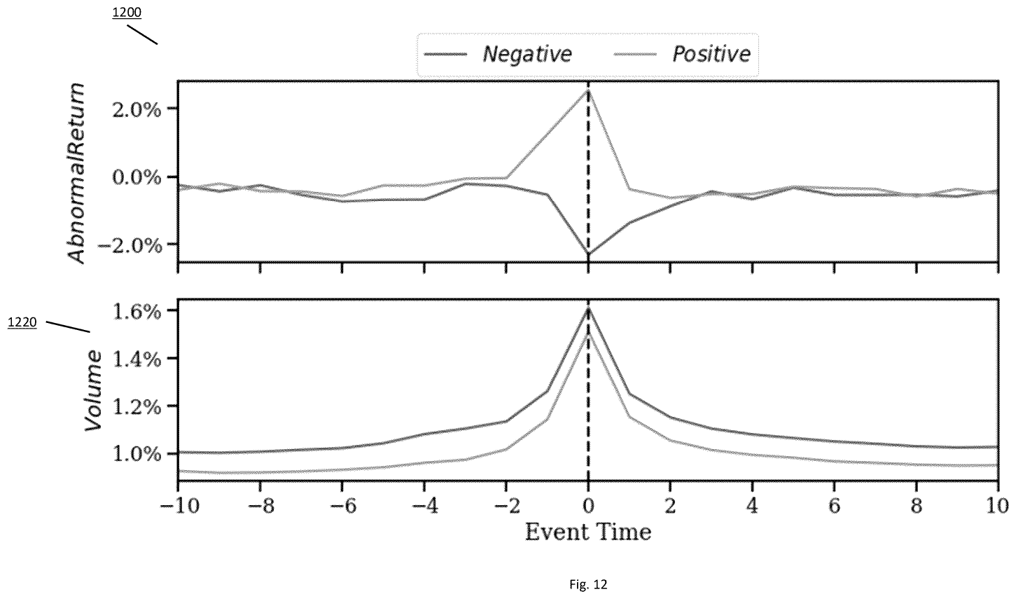

FIG. 12 are graphs 1200 and 1220 plotting example average daily values of AbnormalReturn and Volume in the [−10, 10] day window around the filing date separately for filings that are above and below median Info×FinNeg for current reports.

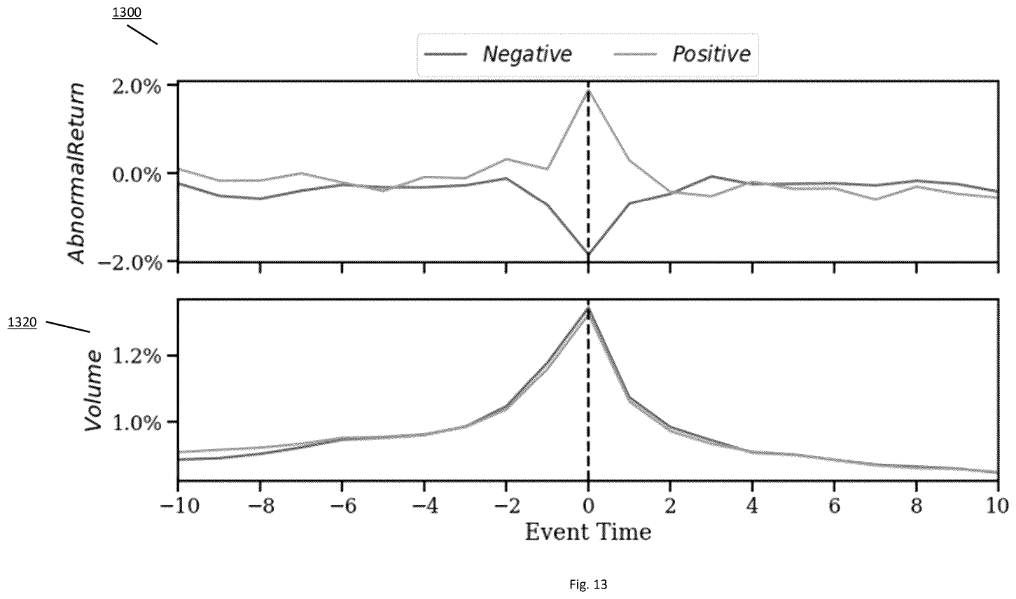

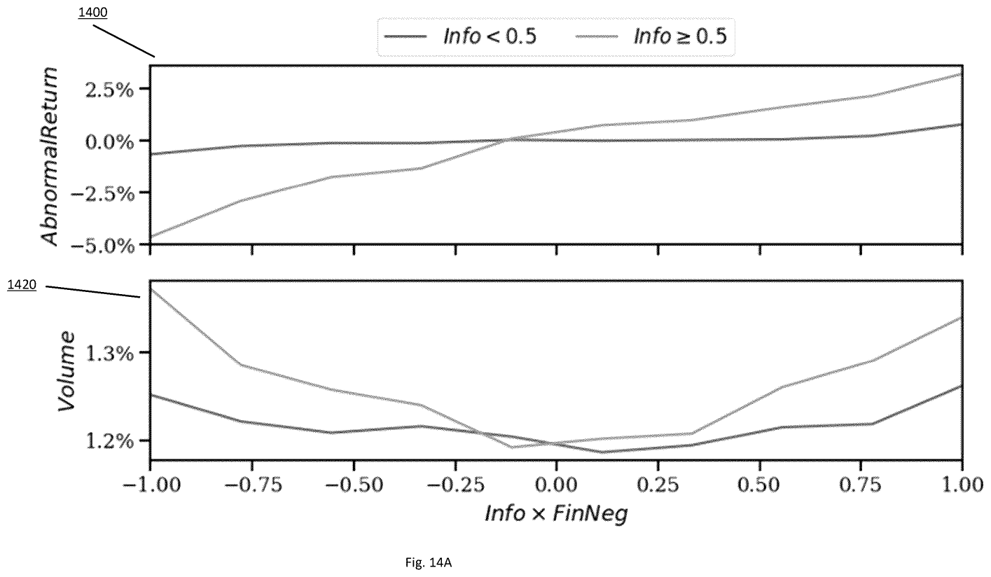

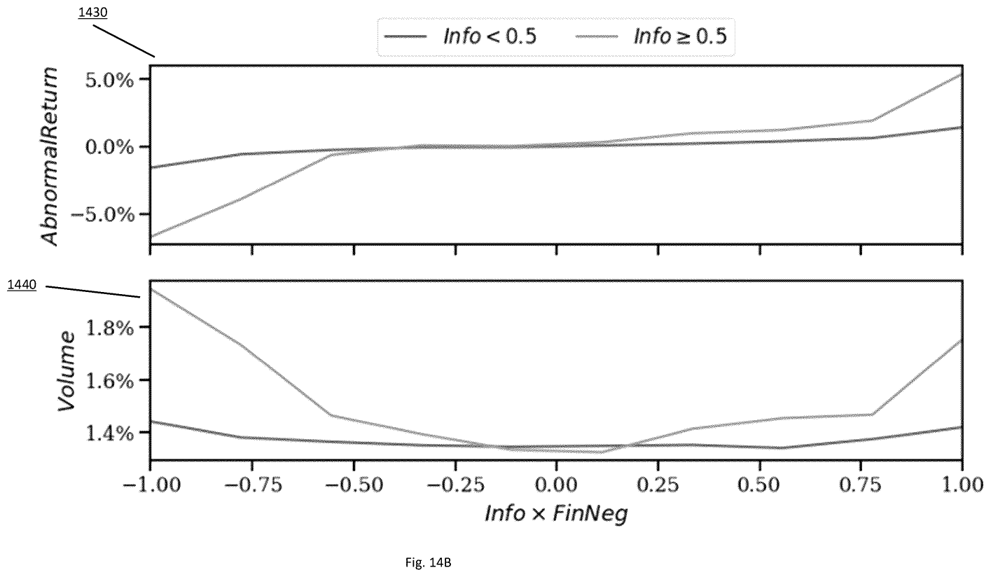

FIG. 13 are graphs 1300 and 1320 plotting example average daily values of AbnormalReturn and Volume in the [−10, 10] day window around the filing date separately for filings that are above and below median Info×FinNeg for Management's Discussion and Analysis (MD&A).

FIGS. 11-13 illustrate a spread in the abnormal return on the filing date, with below median Info×FinNeg filings experiencing negative abnormal returns and above median Info×FinNeg filings experiencing positive abnormal return.

When the information measure is effective at capturing the information content of narrative disclosures, two correlations are expected. First, the AbnormalReturn associated with the filing can be a monotonically increasing function of the information-weighted sentiment, Info×FinNeg. In the case of Volume, a convex relation can be expected. Second, the slope of the relation between AbnormalReturn and Info×FinNeg can be greater for filings that contain more information. In the case of Volume, the convexity of the relation can be expected to increase.

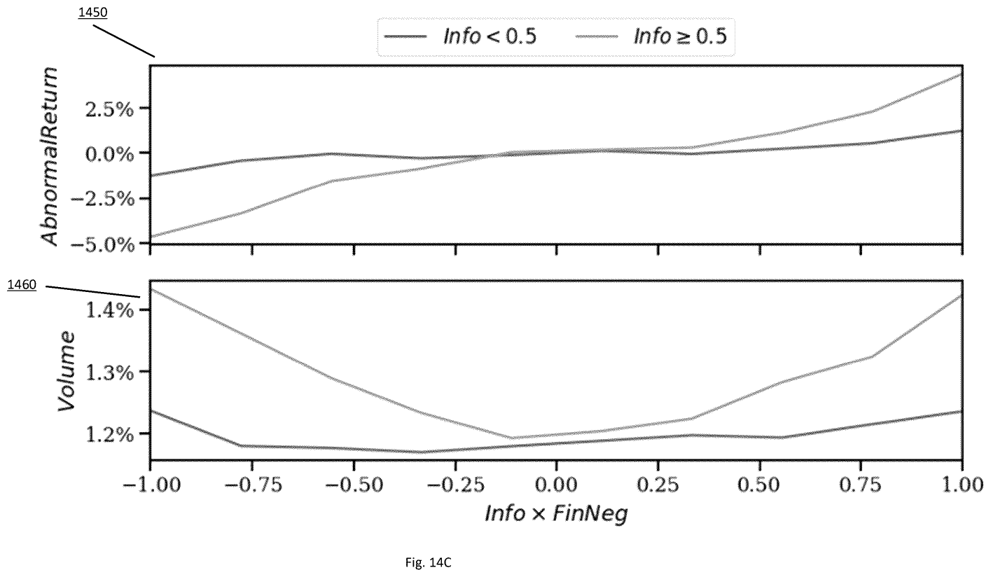

FIG. 14A are graphs 1400 and 1420 that plots example average values of AbnormalReturn in graph 1400 and Volume in graph 1420 for t=0 as a function of Info×FinNeg for annual and quarterly reports. FIG. 14B are graphs 1430 and 1440 that plots example average values of AbnormalReturn in graph 1430 and Volume in graph 1440 for t=0 as a function of Info×FinNeg for current reports. FIG. 14C are graphs 1450 and 1460 that plots example average values of AbnormalReturn in graph 1450 and Volume in graph 1460 for t=0 as a function of Info×FinNeg for annual and quarterly reports.

Across all form types, FIGS. 14A-C illustrate that AbnormalReturn (Volume) can be an increasing (convex) function of Info×FinNeg and that the slope (convexity) of this relation is steeper for more informative filings. To test for a statistically significant relation between AbnormalReturn and Info×FinNeg, the following regression pooling across all firm-dates in the [−10, 10] day window around the filing date can be estimated:

$${AbrnomalReturn}_{f , t} = {β}_{1} Event [ 0 ] + {β}_{2} Event [ 0 ] \times {FinNeg}_{f , j} + γ {X}_{f , t} + {δ}_{t} + {λ}_{f , t} + {ϵ}_{f , t} \qquad ( 8 )$$

where AbnormalReturn can be the daily residual from the expected returns model estimated over the [−70,−11] day window relative to the event, expressed as a percent. FinNeg can be the count of the number of negative words in the filing scaled by the length of the filing multiplied by negative one, then deciled and scaled to range from negative one to one. β₁ and β₂ can be the coefficients of interest, where β₁ can represent the average abnormal return to filings in the lowest decile of Info×FinNeg and β₂ can represent the incremental abnormal return associated with moving from the lowest to highest decile of Info×FinNeg.

Table 9A presents results for annual and quarterly reports, and Table 9B presents results for current reports. In both Table 9A and Table 9B, the results in column (1) can indicate a statistically significant market reaction, on average. However this reaction is not economically significant (e.g., only −5.4 and 7.7 bps for Forms 10-K/Q and Form 8-K, respectively). Column (2) can present results for when FinNeg is interacted with the announcement event. Filings in the lowest decile of FinNeg can be associated with a statistically significant negative event day abnormal return of 7.6 to 10.4 basis points (e.g., t-stats range from −3.071 to −2.281). Moving from the lowest to highest decile of FinNeg can be associated with a statistically significant 18.1 to 26.5 basis points increase in the abnormal return on the event day (e.g., t-stats range from 2.055 to 5.870). Column (3) can present results for the information-weighted sentiment measure, Info×FinNeg. Filings in the lowest decile of Info×FinNeg can be associated with a statistically and economically significant negative event day abnormal return of −254.9 to −156.9 basis points (t-stats range from −49.525 to −24.655). Moving from the lowest to highest decile of the information-weighted sentiment, Info×FinNeg, is associated with a statistically significant and economically massive 318.8 to 524.5 basis points increase in the abnormal return on the event day (e.g., t-stats range from 10.305 to 13.393). Column (4) can present both FinNeg and Info×FinNeg in the regression.

TABLE 9A
Cross-sectional Variation in Market Reaction (Annual and Quarterly Reports)

| | Dependent Variable: | | | |
|---|---|---|---|---|
| | AbnormalReturn | | | |
| Independent Variable | (1) | (2) | (3) | (4) |
| Event[0] | −0.054** | −0.104*** | −1.569*** | −1.631*** |
| | (−2.528) | (−3.071) | (−24.655) | (−23.080) |
| Event[0] × FinNeg | | 0.181** | | 0.230*** |
| | | (2.055) | | (2.690) |
| Event[0] × Info × FinNeg | | | 3.188*** | 3.187*** |
| | | | (13.393) | (13.390) |
| Daily Controls | Y | Y | Y | Y |
| Quarterly Controls | Y | Y | Y | Y |
| Date FEs | Y | Y | Y | Y |
| Firm FEs | Y | Y | Y | Y |
| N-obs | 2,204,716 | 2,204,716 | 2,204,716 | 2,204,716 |
| N-firms | 2,460 | 2,460 | 2,460 | 2,460 |

TABLE 9B
Cross-sectional Variation in Market Reaction (Current Reports)

| | Dependent Variable: | | | |
|---|---|---|---|---|
| | AbnormalReturn | | | |
| Independent Variable | (1) | (2) | (3) | (4) |
| Event[0] | 0.077*** | −0.076** | −2.549*** | −2.652*** |
| | (5.706) | (−2.281) | (−49.525) | (−43.561) |
| Event[0] × FinNeg | | 0.265*** | | 0.179*** |
| | | (5.870) | | (4.144) |
| Event[0] × Info × FinNeg | | | 5.245*** | 5.244*** |
| | | | (10.305) | (10.306) |
| Daily Controls | Y | Y | Y | Y |
| Date FEs | Y | Y | Y | Y |
| Firm-Year-Qtr FEs | Y | Y | Y | Y |
| N-obs | 5,918,652 | 5,918,652 | 5,918,652 | 5,918,652 |
| N-firms | 2,499 | 2,499 | 2,499 | 2,499 |

Collectively, the example evidence of Tables 9A-B highlights the importance of measuring information in the textual data to understand the sentiment. Alternative methods of examining solely 10-K filings find a roughly 25 bps spread between the extreme quintiles of negative sentiment, which is confirmed and validated by the results of embodiments of the models and LLMs disclosed herein. However, when accounting for the interaction between information and sentiment, (e.g., considering sentiment over the informative portion of the document) the effect shown by the example data is more than an order of magnitude greater, (e.g., between 318.7 and 524.5 basis points). This is consistent with the notion that (i) the measure can capture the information in narrative content rather than some other latent time-varying firm characteristic, and (ii) the sentiment of non-informative content should not influence prices.

In some embodiments, additional tests examine the extent to which the measure of information in textual disclosures can be predictive of future firm fundamental performance. The the following model can provide a measure of firm performance:

$${y}_{f , q + t} = {β}_{1} {Info}_{f , q} \times {FinNeg}_{f , q} + γ {X}_{f , q} + {δ}_{q} ++ {ϵ}_{f , q} \qquad ( 9 )$$

where y_{f,q+t} is a measure of firm performance for firm f in quarter q+t. The predictive ability of the measure for horizons ranging from one quarter ahead (t=1), to four years ahead (t=16). The results can be tabulated in a return on assets (“ROA”) metric as a measure of firm performance. As before, Info_{f,q}×FinNeg_{f,q} can be the signed information, (e.g., information-weighted sentiment) for firm f. This measure can be aggregated over firm f's filings for quarter q. In the case of Form 10-K/Q filings, Info_{f,q}×FinNeg_{f,q} is described above. In the case of Form 8-K filings, the arithmetic mean of Info_{f,q}×FinNeg_{f,q} is computed over all filings released during the interval [q−1,q]. X_{f,t} can be a vector of control variables for firm f in quarter q. δ_{q} can be a time fixed effect. β₁ can be the coefficient of interest and represents the incremental change in firm performance associated with moving from the lowest to the highest decile of information-weighted sentiment Info_{f,q}×FinNeg_{f,q}.

Equation 9 can define a predictive regression regarding the value of y_{f,q+t} based solely on information available in quarter q. For analysis of annual and quarterly reports, the Form 10-K/Q filing over which information is computed comes out some time after q but generally before q+1. In that sense, the data required to make predictions were not available until some time after q but before q+1. As a result, introducing a time-invariant fixed effect into the regression is inappropriate since doing so requires foresight into future realizations. For this reason, two versions of Equation 9 are estimated: (a) a levels specification and (b) a differences specification. In some embodiments, a benefit of the difference specification is that any time-invariant firm characteristics, which may be responsible for firm performance, are differenced out.

Table 11A presents results of ROA of form 10-K/Q for annual and quarterly reports. Table 11B presents results of ROA of form 10-K/Q for differences specification. Table 11C presents results of Form 8-K ROA for levels specification. Table 11D presents results of ROA of Form 8-K differences specification. Across Tables 11A-D, a statistically and economically significant relation can be seen between Info×FinNeg and future firm performance as measured by ROA. For example, Table 11A illustrates that moving from the lowest to highest decile of Info×FinNeg can be associated with an 11% increase in ROA during the quarter of disclosure. In some embodiments, this relation is persistent but declining in economic magnitude over time. Specifically, one, two, three, and four years later, the relation is associated with 8.3%, 6.0%, 4.6%, and 4.2% increases in ROA, respectively.

For current reports, there a similar but smaller pattern can be observed. Table 11C shows that during the same quarter, the relation is associated with an increase of 5.6%, while one, two, three, and four years later, it is associated with 3.3%, 2.1%, 0.9%, and 0.8% increases in ROA, respectively. The results from the differences specifications, Table 11B and Table 11D, suggest that this pattern cannot be attributed to an omitted time-invariant firm characteristic.

TABLE 11A
Annual and Quarterlty Reports (Forms 10-K/Q) - Levels Specification

| | Dependent Variable: | | | | | |
|---|---|---|---|---|---|---|
| | ROA_{q} | ROA_{q+1} | ROA_{q+2} | ROA_{q+3} | ROA_{q+4} | ROA_{q+5} |
| | (1) | (2) | (3) | (4) | (5) | (6) |
| Info × FinNeg | 0.207*** | 0.178*** | 0.173*** | 0.188*** | 0.161*** | 0.133*** |
| | (15.746) | (13.302) | (11.794) | (12.738) | (10.540) | (9.957) |
| Controls | Y | Y | Y | Y | Y | Y |
| Year FE | Y | Y | Y | Y | Y | Y |
| Observations | 82,650 | 82,091 | 81,753 | 81,453 | 81,151 | 80,995 |
| Firms | 2,327 | 2,318 | 2,315 | 2,316 | 2,314 | 2,312 |
| F | 1639.0*** | 1598.0*** | 1510.0*** | 1529.8*** | 1495.0*** | 1421.9*** |
| R² | 0.205 | 0.202 | 0.194 | 0.196 | 0.193 | 0.186 |
| Within R² | 0.187 | 0.159 | 0.182 | 0.189 | 0.164 | 0.179 |

| | Dependent Variable: | | | | |
|---|---|---|---|---|---|
| | ROA_{q+6} | ROA_{q+7} | ROA_{q+8} | ROA_{q+12} | ROA_{q+16} |
| | (7) | (8) | (9) | (10) | (11) |
| Info × FinNeg | 0.120*** | 0.144*** | 0.116** | 0.089*** | 0.082*** |
| | (9.367) | (11.127) | (8.056) | (5.498) | (5.663) |
| Controls | Y | Y | Y | Y | Y |
| Year FE | Y | Y | Y | Y | Y |
| Observations | 80,847 | 80,675 | 78,871 | 71,169 | 63,918 |
| Firms | 2,313 | 2,311 | 2,265 | 2,086 | 1,933 |
| F | 1345.8*** | 1331.9*** | 1221.9*** | 908.0*** | 653.0*** |
| R² | 0.178 | 0.177 | 0.168 | 0.142 | 0.117 |
| Within R² | 0.169 | 0.170 | 0.157 | 0.140 | 0.110 |

TABLE 11B
Annual and Quarterly Reports (Forms 10-K/Q) - Differences Specification

| | Dependent Variable: | | | | | |
|---|---|---|---|---|---|---|
| | ΔROA_{q} | ΔROA_{q+1} | ΔROA_{q+2} | ΔROA_{q+3} | ΔROA_{q+4} | ΔROA_{q+5} |
| | (1) | (2) | (3) | (4) | (5) | (6) |
| ΔInfo × FinNeg | 0.038** | 0.069*** | 0.055*** | 0.019* | 0.065*** | 0.045*** |
| | (2.436) | (4.334) | (4.003) | (1.766) | (4.938) | (3.778) |
| Controls | Y | Y | Y | Y | Y | Y |
| Year FE | Y | Y | Y | Y | Y | Y |
| Observations | 82,650 | 82,475 | 82,396 | 82,331 | 82,268 | 82,203 |
| Firms | 2,327 | 2,318 | 2,315 | 2,316 | 2,314 | 2,312 |
| F | 2430.0*** | 175.0*** | 135.9*** | 127.7*** | 119.2*** | 98.4*** |
| R² | 0.277 | 0.269 | 0.210 | 0.198 | 0.185 | 0.153 |
| Within R² | 0.281 | 0.149 | 0.164 | 0.172 | 0.159 | 0.143 |

| | Dependent Variable: | | | | |
|---|---|---|---|---|---|
| | ΔROA_{q+6} | ΔROA_{q+7} | ΔROA_{q+8} | ΔROA_{q+12} | ΔROA_{q+16} |
| | (7) | (8) | (9) | (10) | (11) |
| ΔInfo × FinNeg | 0.035*** | 0.023* | 0.055*** | 0.034*** | 0.027*** |
| | (2.623) | (1.941) | (3.955) | (4.114) | (3.552) |
| Controls | Y | Y | Y | Y | Y |
| Year FE | Y | Y | Y | Y | Y |
| Observations | 82,146 | 82,072 | 80,303 | 72,561 | 65,209 |
| Firms | 2,313 | 2,311 | 2,265 | 2,086 | 1,933 |
| F | 83.7*** | 96.4*** | 77.8*** | 55.0*** | 21.6*** |
| R² | 0.131 | 0.150 | 0.124 | 0.098 | 0.043 |
| Within R² | 0.141 | 0.154 | 0.127 | 0.088 | 0.041 |

TABLE 11C
Current Reports (Form 8-K) Levels Specification

| | Dependent Variable: | | | | | |
|---|---|---|---|---|---|---|
| | ROA_{q} | ROA_{q+1} | ROA_{q+2} | ROA_{q+3} | ROA_{q+4} | ROA_{q+5} |
| | (1) | (2) | (3) | (4) | (5) | (6) |
| Info × FinNeg | 0.109*** | 0.117*** | 0.086*** | 0.071*** | 0.063*** | 0.059*** |
| | (11.220) | (12.042) | (9.930) | (8.799) | (8.442) | (8.265) |
| Controls | Y | Y | Y | Y | Y | Y |
| Year FE | Y | Y | Y | Y | Y | Y |
| Observations | 81,420 | 80,906 | 80,568 | 80,267 | 79,976 | 79,824 |
| Firms | 2,287 | 2,280 | 2,278 | 2,277 | 2,276 | 2,274 |
| F | 1563.4*** | 1564.4*** | 1464.1*** | 1432.8*** | 1411.7*** | 1357.4*** |
| R² | 0.200 | 0.201 | 0.191 | 0.188 | 0.187 | 0.181 |
| Within R² | 0.174 | 0.135 | 0.181 | 0.163 | 0.157 | 0.184 |

| | Dependent Variable: | | | | |
|---|---|---|---|---|---|
| | ROA_{q+6} | ROA_{q+7} | ROA_{q+8} | ROA_{q+12} | ROA_{q+16} |
| | (7) | (8) | (9) | (10) | (11) |
| Info × FinNeg | 0.044*** | 0.039*** | 0.040*** | 0.018* | 0.016* |
| | (5.822) | (4.748) | (4.940) | (1.942) | (1.657) |
| Controls | Y | Y | Y | Y | Y |
| Year FE | Y | Y | Y | Y | Y |
| Observations | 79,675 | 79,535 | 79,372 | 71,552 | 64,234 |
| Firms | 2,267 | 2,262 | 2,263 | 2,087 | 1,935 |
| F | 1296.4*** | 1255.0*** | 1193.2*** | 868.5*** | 609.7*** |
| R² | 0.175 | 0.170 | 0.164 | 0.136 | 0.110 |
| Within R² | 0.163 | 0.166 | 0.141 | 0.113 | 0.104 |

TABLE 11D
Current Reports (Form 8-K) Differences Specification

| | Dependent Variable: | | | | | |
|---|---|---|---|---|---|---|
| | ΔROA_{q} | ΔROA_{q+1} | ΔROA_{q+2} | ΔROA_{q+3} | ΔROA_{q+4} | ΔROA_{q+5} |
| | (1) | (2) | (3) | (4) | (5) | (6) |
| ΔInfo × FinNeg | 0.008*** | 0.024*** | 0.012*** | 0.009*** | 0.008*** | 0.013*** |
| | (4.376) | (11.142) | (5.052) | (4.351) | (3.257) | (7.053) |
| Controls | Y | Y | Y | Y | Y | Y |
| Year FE | Y | Y | Y | Y | Y | Y |
| Observations | 81,420 | 80,906 | 80,568 | 80,267 | 79,976 | 79,824 |
| Firms | 2,287 | 2,280 | 2,278 | 2,277 | 2,276 | 2,274 |
| F | 1582.6*** | 201.1*** | 390.3*** | 533.9*** | 220.0*** | 231.9*** |
| R² | 0.202 | 0.313 | 0.593 | 0.796 | 0.345 | 0.364 |
| Within R² | 0.206 | 0.409 | 0.636 | 0.842 | 0.359 | 0.306 |

| | Dependent Variable: | | | | |
|---|---|---|---|---|---|
| | ΔROA_{q+6} | ΔROA_{q+7} | ΔROA_{q+8} | ΔROA_{q+12} | ΔROA_{q+16} |
| | (7) | (8) | (9) | (10) | (11) |
| ΔInfo × FinNeg | 0.005* | 0.003 | 0.006*** | 0.006*** | 0.005* |
| | (1.713) | (1.382) | (4.181) | (5.483) | (1.665) |
| Controls | Y | Y | Y | Y | Y |
| Year FE | Y | Y | Y | Y | Y |
| Observations | 79,675 | 79,535 | 79,372 | 71,552 | 64,234 |
| Firms | 2,267 | 2,262 | 2,263 | 2,087 | 1,935 |
| F | 373.2*** | 470.8*** | 272.0*** | 281.7*** | 274.4*** |
| R² | 0.574 | 0.715 | 0.427 | 0.487 | 0.526 |
| Within R² | 0.467 | 0.720 | 0.409 | 0.383 | 0.405 |

In some embodiments, the relation between the measure of signed information and long-run returns can be examined. The predictive ability of Info×FinNeg can be tested for long-run returns by re-estimating Equation 9 using quarterly abnormal returns, BHAR, for y_{f,q+t}. Within each firm-quarter in the sample, the expected returns model can be estimated using daily returns data. BHAR can be defined as the intercept from the expected returns model (e.g., the “alpha”) multiplied by the number of trading days during the quarter and expressed as a percent. In some embodiments, this approach controls for time-varying firm characteristics (e.g., risk exposure) which varies at the firm-year-quarter frequency or slower. In some embodiments, firm characteristics such as size and value are controlled for via factor loadings and are not included when re-estimating Equation 9.

In some embodiments, β₁ is the coefficient of interest that represents the incremental change in BHAR associated with moving from the lowest to highest decile of Info_{f,q}×FinNeg_{f,q}. β₁ can, in some embodiments, be considered the return on a portfolio which is long on firms with above median Info_{f,q}×FinNeg_{f,q} and short on firms those below the median. However, this second interpretation needs qualification due to the presence of control variables and year-fixed effects.

In some embodiments, if markets are efficient in the sense that all publicly available information is fully reflected in price, there should not be a statistically significant relation between BHAR and signed information. In some embodiments, if markets are inefficient in the sense that there is information contained in Form 10-K/Q and 8-K filings that is not fully priced, it is expected there is evidence of a statistically and economically significant relation between BHAR and signed information. In some embodiments, if markets are relatively efficient but there are limits to arbitrage such as trading costs in the form of spreads and price impact, then there can be a statistically but not economically significant relation.

Table 12A presents results of the BHAR metric for annual and quarterly reports. Table 12B presents results of the BHAR metric for annual and quarterly reports. Tables 12A-B present statistically significant association between BHAR and Info_{f,q}×FinNeg_{f,q}, with t-statistics ranging from 3.404 to 9.799. In some examples, this relation is economically small with the effect running in magnitude from 35.2 down to 7.30 basis points per quarter (or 141 to 29 basis points per year). This evidence is consistent with the notion that the market impounds the information contained in narrative disclosure within a matter of days.

TABLE 12A
Annual and Quarterly Reports (Forms 10-K/Q)

| | Dependent Variable: | | | | | |
|---|---|---|---|---|---|---|
| | BHAR_{q} | BHAR_{q+1} | BHAR_{q+2} | BHAR_{q+3} | BHAR_{q+4} | BHAR_{q+5} |
| | (1) | (2) | (3) | (4) | (5) | (6) |
| Info × FinNeg | 0.280*** | 0.352*** | 0.291*** | 0.212*** | 0.232*** | 0.322*** |
| | (3.913) | (5.781) | (9.799) | (7.327) | (4.540) | (7.278) |
| Controls | Y | Y | Y | Y | Y | Y |
| Year FE | Y | Y | Y | Y | Y | Y |
| Observations | 82,650 | 82,454 | 82,352 | 82,268 | 82,191 | 82,106 |
| Firms | 2,327 | 2,325 | 2,325 | 2,325 | 2,323 | 2,321 |
| F | 23.1*** | 34.5*** | 25.6*** | 21.7*** | 26.0*** | 42.0*** |
| R² | 0.025 | 0.038 | 0.028 | 0.024 | 0.028 | 0.046 |
| Within R² | 0.017 | 0.023 | 0.019 | 0.016 | 0.018 | 0.037 |

| | Dependent Variable: | | | | |
|---|---|---|---|---|---|
| | BHAR_{q+6} | BHAR_{q+7} | BHAR_{q+8} | BHAR_{q+12} | BHAR_{q+16} |
| | (7) | (8) | (9) | (10) | (11) |
| Info × FinNeg | 0.219*** | 0.189*** | 0.187*** | 0.170*** | 0.148*** |
| | (9.115) | (6.709) | (5.267) | (4.173) | (3.561) |
| Controls | Y | Y | Y | Y | Y |
| Year FE | Y | Y | Y | Y | Y |
| Observations | 82,029 | 81,937 | 80,159 | 72,403 | 65,059 |
| Firms | 2,322 | 2,320 | 2,274 | 2,096 | 1,943 |
| F | 29.9*** | 24.0*** | 21.1*** | 17.0*** | 12.9*** |
| R² | 0.033 | 0.026 | 0.024 | 0.021 | 0.018 |
| Within R² | 0.026 | 0.020 | 0.016 | 0.010 | 0.007 |

TABLE 12B
Current Reports (Form 8-K)

| | Dependent Variable: | | | | | |
|---|---|---|---|---|---|---|
| | BHAR_{q} | BHAR_{q+1} | BHAR_{q+2} | BHAR_{q+3} | BHAR_{q+4} | BHAR_{q+5} |
| | (1) | (2) | (3) | (4) | (5) | (6) |
| Info × FinNeg | 0.215*** | 0.230*** | 0.280*** | 0.182*** | 0.173*** | 0.169*** |
| | (3.904) | (4.498) | (6.713) | (8.702) | (4.434) | (4.643) |
| Controls | Y | Y | Y | Y | Y | Y |
| Year FE | Y | Y | Y | Y | Y | Y |
| Observations | 83,768 | 83,602 | 83,494 | 83,399 | 83,311 | 83,240 |
| Firms | 2,296 | 2,294 | 2,293 | 2,293 | 2,291 | 2,290 |
| F | 19.2*** | 26.2*** | 26.8*** | 25.9*** | 22.2*** | 28.4*** |
| R² | 0.021 | 0.028 | 0.029 | 0.028 | 0.024 | 0.031 |
| Within R² | 0.018 | 0.020 | 0.020 | 0.020 | 0.018 | 0.024 |

| | Dependent Variable: | | | | |
|---|---|---|---|---|---|
| | BHAR_{q+6} | BHAR_{q+7} | BHAR_{q+8} | BHAR_{q+12} | BHAR_{q+16} |
| | (7) | (8) | (9) | (10) | (11) |
| Info × FinNeg | 0.114*** | 0.137*** | 0.073*** | 0.112*** | 0.087*** |
| | (4.579) | (5.648) | (2.818) | (3.821) | (3.404) |
| Controls | | Y | Y | Y | Y |
| Year FE | Y | Y | Y | Y | Y |
| Observations | 83,162 | 83,092 | 83,002 | 74,976 | 67,415 |
| Firms | 2,287 | 2,287 | 2,284 | 2,104 | 1,951 |
| F | 25.7*** | 24.5*** | 18.6*** | 14.8*** | 10.8*** |
| R² | 0.028 | 0.026 | 0.020 | 0.018 | 0.014 |
| Within R² | 0.023 | 0.021 | 0.017 | 0.010 | 0.006 |

Although narrative disclosure is a frequent form of communication by firms to outside stakeholders, most studies examining the reaction to new information have focused on quantitative information such as earnings. In some embodiments, LLMs measure investors' prior beliefs about disclosure and then these priors can uncover new information contained in textual data. From there, the value of narrative content can be studied in capital markets.

### Methods of Training and Using the Models

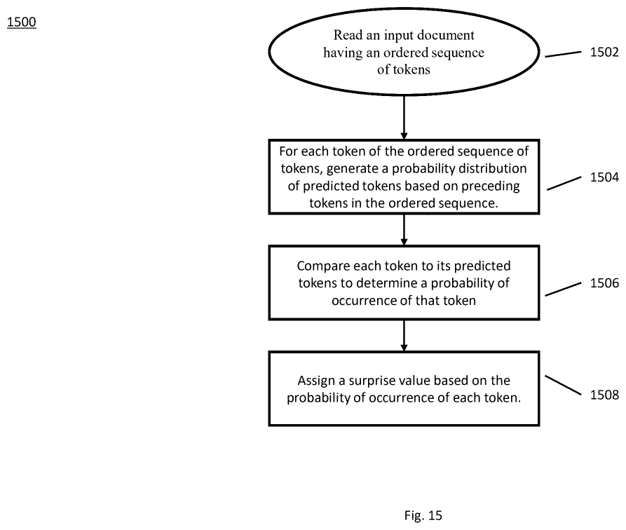

FIG. 15 is a flowchart 1500 illustrating a method of uncovering high-surprisal information according to embodiments of the present disclosure. In some embodiments, a domain-specific large language model (e.g., domain-specific model 132 of FIG. 1C) reads an input document having an ordered sequence of tokens 1502. In some embodiments, the input document is processed by a tokenizer to generate the ordered sequence of tokens. For each token of the ordered sequence of tokens, the domain-specific large language model can generate a probability distribution of predicted tokens based on preceding tokens in the ordered sequence 1504. The domain-specific model can compare each token to its predicted tokens to determine a probability of occurrence of that token 1506. The domain-specific model can assign a surprise value based on the occurrence of each token 1508.

In some embodiments, the surprise value of each token can be averaged or combined with other tokens to provide a combined surprise value at the word, phrase, sentence, paragraph, section, or document level.

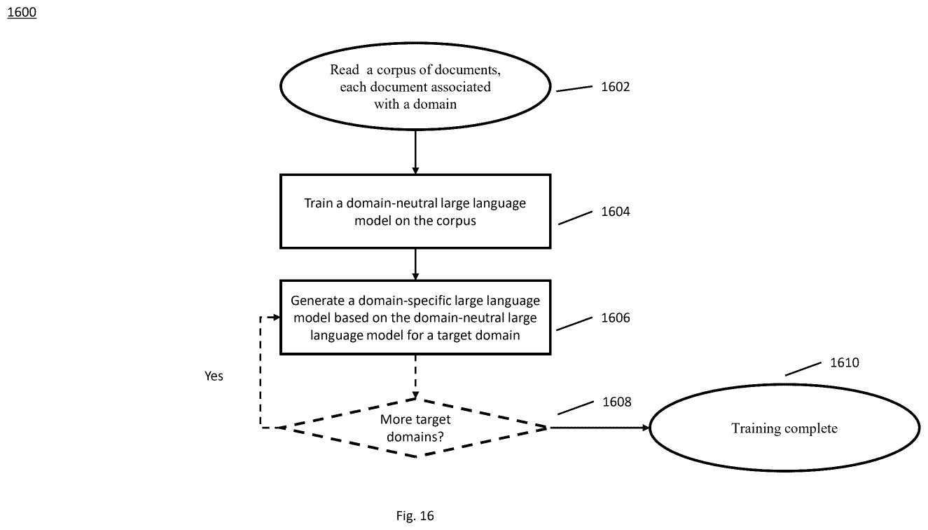

FIG. 16 is a flowchart 1600 illustrating a method of training a model to uncover high-surprisal information. A model training factory (e.g., LLM training factory 112 of FIGS. 1A-B) can read a corpus of documents 1602. Each document in the corpus can be associated with a domain. The model training factory can train a domain-neutral large language model on the corpus 1604. The model training factory can further generate a domain-specific large language model based on the domain-neutral large language model for a target domain 1606.

In some embodiments, optionally, the model training factory can determine whether additional models should be trained for more target domains, such as the domains associated with documents in the corpus 1608. If so, the model training factory generates a domain-specific large language model for the next target domain 1606. This optional process can iterate until there are no more target domain to generate a domain-specific model and model training is complete 1610.

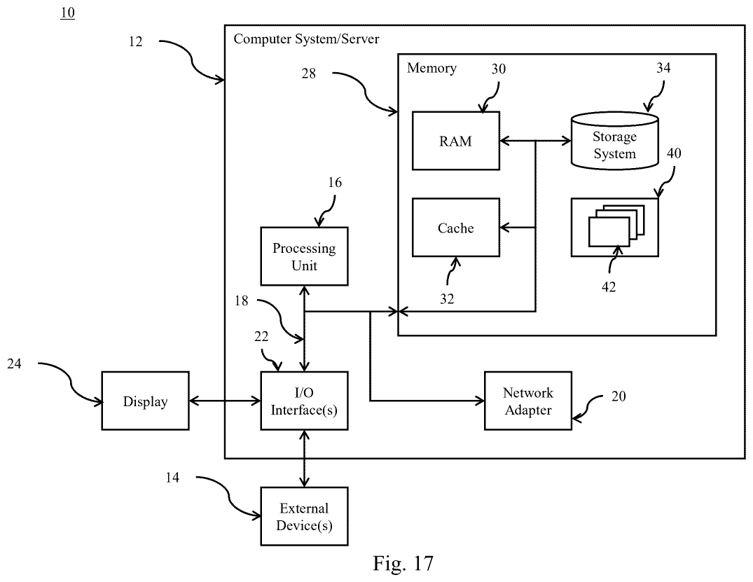

FIG. 17 is a computing node according to embodiments of the present disclosure. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 17, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of surfacing high-surprisal information, the method comprising:
reading an input document, the input document comprising an ordered sequence of tokens;
for each token of the ordered sequence of tokens, generating by a language model a probability distribution of predicted tokens based on preceding tokens in the ordered sequence;
comparing each token to its predicted tokens to determine a probability of occurrence of that token; and
based on the probability of occurrence of each token, assigning a surprise value thereto.

2. The method of claim 1, wherein the language model is trained by:
reading a corpus of documents, each document of the corpus being associated with a context of a plurality of contexts,
training a domain-neutral language model on the corpus of documents, and
generating a domain-specific language model based on the domain-neutral language model, the domain-specific language model being associated with a target context and a plurality of documents associated with the target context.

3. The method of claim 2, wherein generating the domain-specific language model further comprises:
training the domain-specific language model based on a plurality of documents associated with the target context.

4. The method of claim 2, wherein the target context is one of the plurality of contexts.

5. The method of claim 2, wherein training the domain-neutral language model on the corpus of documents comprises:
for each of a plurality of parameters of the domain-neutral language model, initializing that parameter with a random value.

6. The method of claim 2, wherein generating the domain-specific language model further comprises:
initializing a first plurality of parameters of the domain-specific language model with a second plurality of parameters of the domain-neutral language model.

7. The method of claim 2, wherein the domain-neutral language model and domain-specific language model each employ a transformer neural network architecture.

8. The method of claim 2, wherein the domain-specific language model is further trained by:
tokenizing each document of the corpus to a plurality of tokens, wherein
training the domain-neutral language model is based on the pluralities of tokens.

9. The method of claim 2, wherein
each document of the corpus has an associated creation time,
the input document has an associated creation time later than the creation times of the documents of the corpus.

10. The method of claim 1, further comprising:
assigning a plurality of tokens to a prediction window;
combining the surprise value of each token of the plurality of tokens assigned to the prediction window; and
providing a prediction window surprise value based on the combined surprise values.

11. The method of claim 10, wherein the prediction window corresponds to a phrase, sentence, or paragraph.

12. The method of claim 1, wherein
the surprise value is a difference between the probability of occurrence and a highest expected probability in the probability distribution.

13. The method of claim 1, further comprising:
displaying the input document with a visualization of the surprise value associated with each of the ordered sequence of tokens.

14. The method of claim 13, wherein the visualization comprises a level of highlighting proportional to the surprise value.

15. The method of claim 13, wherein the visualization comprises a variation in one or more of font, color, size, and visibility.

16. A method of training a language model, the method comprising:
reading a corpus of documents, each document of the corpus being associated with a context of a plurality of contexts;
training a domain-neutral language model on the corpus of documents; and
generating a domain-specific language model based on the domain-neutral language model, the domain-specific language model being associated with a target context, wherein
the domain-specific language model is configured to receive an input document, the input document comprising an ordered sequence of tokens,
for each token of the ordered sequence of tokens, generate a probability distribution of predicted tokens based on preceding tokens in the ordered sequence,
compare each token to its predicted tokens to determine a probability of occurrence of that token, and
based on the probability of occurrence of each token, assign a surprise value thereto.

17. The method of claim 16, wherein generating the domain-specific language model further comprises:
training the domain-specific language model based on a plurality of documents associated with the target context.

18. The method of claim 16, wherein the target context is one of the plurality of contexts.

19. The method of claim 16, wherein training the domain-neutral language model on the corpus of documents comprises:
for each of a plurality of parameters of the domain-neutral language model, initializing that parameter with a random value.

20. The method of claim 16, wherein generating the domain-specific language model further comprises:
initializing a first plurality of parameters of the domain-specific language model with a second plurality of parameters of the domain-neutral language model.

21. The method of claim 16, wherein the domain-neutral language model and domain-specific language model each employ a transformer neural network architecture.

22. The method of claim 16, further comprising:
tokenizing each document of the corpus to a plurality of tokens, wherein
the domain-neutral language model is further trained on the pluralities of tokens.

23. The method of claim 16, wherein the domain-specific language model is further configured to:
assign a plurality of tokens to a prediction window,
combine the surprise value of each token of the plurality of tokens assigned to the prediction window, and
provide a prediction window surprise value based on the combined surprise values.

24. The method of claim 23, wherein the prediction window corresponds to a phrase, sentence, or paragraph.

25. The method of claim 16, wherein
the surprise value is a difference between the probability of occurrence and a highest expected probability in the probability distribution.

26. A computer program product comprising a computer readable storage medium having program instructions embodied therewith, the program instructions executable to perform operations comprising:
reading an input document, the input document comprising an ordered sequence of tokens,
for each token of the ordered sequence of tokens, generating by a language model a probability distribution of predicted tokens based on preceding tokens in the ordered sequence,
comparing each token to its predicted tokens to determine a probability of occurrence of that token, and
based on the probability of occurrence of each token, assigning a surprise value thereto.
